(19) United States
(12) Patent Application Publication
(10) Pub. No.: US 2022/0078746 A1
(43) Pub. Date: Mar. 10, 2022

(54) DE-PRIORITIZATION OF NON-TERRESTRIAL NETWORK CELLS NOT PROVIDING CURRENT TRACKING AREA CODE OF USER EQUIPMENT

(71) Applicant: LG ELECTRONICS INC., Seoul (KR)

(72) Inventors: Oanyong LEE, Seoul (KR); Sangwon KIM, Seoul (KR)

(73) Assignee: LG ELECTRONICS INC., Seoul (KR)

(21) Appl. No.: 17/309,976

(22) PCT Filed: Mar. 26, 2020
(86) PCT No.: PCT/KR2020/004082

§ 371 Date: Jul. 7, 2021

(30) Foreign Application Priority Data
Mar. 27, 2019 (KR) 10-2019-0035271
Mar. 27, 2019 (KR) 10-2019-0035310

(51) Int. Cl. H04W 64/00; H04B 7/185; H04W 48/20; H04W 36/08

(52) U.S. Cl. CPC H04W 64/003; H04B 7/18513; H04W 84/06; H04W 36/08; H04W 48/20

(57) ABSTRACT

A method and apparatus for de-prioritization of non-terrestrial networks (NTN) cells not providing current tracking area code (TAC) of a user equipment (UE) in a wireless communication system is provided. The UE, which is camping on a NTN cell, receives, from a network node serving the NTN cell, information on multiple TACs, and de-prioritizes the NTN cell based on that a TAC of an area where the wireless device is currently located is not included in the multiple TACs.

### TECHNICAL FIELD

The present disclosure relates to de-prioritization of non-terrestrial networks (NTN) cells not providing current tracking area code (TAC) of a user equipment (UE).

### BACKGROUND

3rd generation partnership project (3GPP) long-term evolution (LTE) is a technology for enabling high-speed packet communications. Many schemes have been proposed for the LTE objective including those that aim to reduce user and provider costs, improve service quality, and expand and improve coverage and system capacity. The 3GPP LTE requires reduced cost per bit, increased service availability, flexible use of a frequency band, a simple structure, an open interface, and adequate power consumption of a terminal as an upper-level requirement.

Work has started in international telecommunication union (ITU) and 3GPP to develop requirements and specifications for new radio (NR) systems. 3GPP has to identify and develop the technology components needed for successfully standardizing the new RAT timely satisfying both the urgent market needs, and the more long-term requirements set forth by the ITU radio communication sector (ITU-R) international mobile telecommunications (IMT)-2020 process. Further, the NR should be able to use any spectrum band ranging at least up to 100 GHz that may be made available for wireless communications even in a more distant future.

The NR targets a single technical framework addressing all usage scenarios, requirements and deployment scenarios including enhanced mobile broadband (eMBB), massive machine-type-communications (mMTC), ultra-reliable and low latency communications (URLLC), etc. The NR shall be inherently forward compatible.

Thanks to the wide service coverage capabilities and reduced vulnerability of space/airborne vehicles to physical attacks and natural disasters, non-terrestrial networks (NTN) are expected to:
foster the roll out of 5G service in un-served areas that cannot be covered by terrestrial 5G network (isolated/remote areas, on board aircrafts or vessels) and underserved areas (e.g., sub-urban/rural areas) to upgrade the performance of limited terrestrial networks in cost effective manner,
reinforce the 5G service reliability by providing service continuity for machine-to-machine (M2M)/Internet-of-things (IoT) devices or for passengers on board moving platforms (e.g., passenger vehicles-aircraft, ships, high speed trains, bus) or ensuring service availability anywhere especially for critical communications, future railway/maritime/aeronautical communications, and to
enable 5G network scalability by providing efficient multicast/broadcast resources for data delivery towards the network edges or even user terminal.

### SUMMARY

Due to nature of NTN, specifically NTN served by non-geostationary Earth orbit (GEO) satellites, a current tracking area mechanism should be addressed and/or discussed.

In an aspect, a method for a wireless device in a wireless communication system is provided. The wireless device, which is camping on a non-terrestrial networks (NTN) cell, receives, from a network node serving the NTN cell, information on multiple tracking area codes (TACs), and de-prioritizes the NTN cell based on that a TAC of an area where the wireless device is currently located is not included in the multiple TACs.

In another aspect, an apparatus for implementing the above method is provided.

The present disclosure can have various advantageous effects.

For example, for the UEs knowing its current location and corresponding TAI list, if an NTN cell broadcasts TAC(s) and the TAC(s) does not belong to the TAI list of the UE, the UE can de-prioritize the NTN cell to camp on.

For example, unnecessary access attempt and/or tracking area update can be prevented.

Advantageous effects which can be obtained through specific embodiments of the present disclosure are not limited to the advantageous effects listed above. For example, there may be a variety of technical effects that a person having ordinary skill in the related art can understand and/or derive from the present disclosure. Accordingly, the specific effects of the present disclosure are not limited to those explicitly described herein, but may include various effects that may be understood or derived from the technical features of the present disclosure.

### BRIEF DESCRIPTION OF THE DRAWINGS

FIG. 1 shows an example of a communication system to which implementations of the present disclosure is applied.

FIG. 2 shows an example of wireless devices to which implementations of the present disclosure is applied.

FIG. 3 shows an example of a wireless device to which implementations of the present disclosure is applied.

FIG. 4 shows another example of wireless devices to which implementations of the present disclosure is applied.

FIG. 5 shows an example of UE to which implementations of the present disclosure is applied.

FIGS. 6 and 7 show an example of protocol stacks in a 3GPP based wireless communication system to which implementations of the present disclosure is applied.

FIG. 8 shows a frame structure in a 3GPP based wireless communication system to which implementations of the present disclosure is applied.

FIG. 9 shows a data flow example in the 3GPP NR system to which implementations of the present disclosure is applied.

FIG. 10 shows an example of SSB to which implementations of the present disclosure is applied.

FIG. 11 shows an example of SI acquisition procedure to which implementations of the present disclosure is applied.

FIG. 12 shows an example of contention-based random access (CBRA) to which implementations of the present disclosure is applied.

FIG. 13 shows an example of contention-free random access (CFRA) to which implementations of the present disclosure is applied.

FIG. 14 shows a concept of threshold of the SSB for RACH resource association to which implementations of the present disclosure is applied.

FIG. 15 shows an example of operation of power ramping counter to which implementations of the present disclosure is applied.

FIG. 16 shows an example of satellite access network (without ISL) with a service link operating in frequency bands above 6 GHz allocated to fixed and mobile satellite services (FSS and MSS) to which implementations of the present disclosure is applied.

FIG. 17 shows an example of satellite access network (with ISL) with a service link operating in frequency bands above 6 GHz allocated to FSS and MSS to which implementations of the present disclosure is applied.

FIG. 18 shows an example of satellite access network with a service link operating in frequency bands below 6 GHz allocated to MSS to which implementations of the present disclosure is applied.

FIG. 19 shows an example of satellite access network which service link operates below 6 GHz frequency bands allocated to MSS and complemented with the terrestrial access network served by the same or independent core networks to which implementations of the present disclosure is applied.

FIG. 20 shows an example of updating TAC and PLMN ID in real-time to which implementations of the present disclosure is applied.

FIG. 21 shows an example of a method for a wireless device to which implementations of the present disclosure is applied.

FIG. 22 shows an example of a NTN cell broadcasting geographical-fixed TACs at a first time point to which implementations of the present disclosure is applied.

FIG. 23 shows an example of a NTN cell broadcasting geographical-fixed TACs at a second time point to which implementations of the present disclosure is applied.

### DETAILED DESCRIPTION

The following techniques, apparatuses, and systems may be applied to a variety of wireless multiple access systems. Examples of the multiple access systems include a code division multiple access (CDMA) system, a frequency division multiple access (FDMA) system, a time division multiple access (TDMA) system, an orthogonal frequency division multiple access (OFDMA) system, a single carrier frequency division multiple access (SC-FDMA) system, and a multicarrier frequency division multiple access (MC-FDMA) system. CDMA may be embodied through radio technology such as universal terrestrial radio access (UTRA) or CDMA2000. TDMA may be embodied through radio technology such as global system for mobile communications (GSM), general packet radio service (GPRS), or enhanced data rates for GSM evolution (EDGE). OFDMA may be embodied through radio technology such as institute of electrical and electronics engineers (IEEE) 802.11 (Wi-Fi), IEEE 802.16 (WiMAX), IEEE 802.20, or evolved UTRA (E-UTRA). UTRA is a part of a universal mobile telecommunications system (UMTS). 3rd generation partnership project (3GPP) long term evolution (LTE) is a part of evolved UMTS (E-UMTS) using E-UTRA. 3GPP LTE employs OFDMA in DL and SC-FDMA in UL. LTE-advanced (LTE-A) is an evolved version of 3GPP LTE.

For convenience of description, implementations of the present disclosure are mainly described in regards to a 3GPP based wireless communication system. However, the technical features of the present disclosure are not limited thereto. For example, although the following detailed description is given based on a mobile communication system corresponding to a 3GPP based wireless communication system, aspects of the present disclosure that are not limited to 3GPP based wireless communication system are applicable to other mobile communication systems.

For terms and technologies which are not specifically described among the terms of and technologies employed in the present disclosure, the wireless communication standard documents published before the present disclosure may be referenced.

In the present disclosure, “A or B” may mean “only A”, “only B”, or “both A and B”. In other words, “A or B” in the present disclosure may be interpreted as “A and/or B”. For example, “A, B or C” in the present disclosure may mean “only A”, “only B”, “only C”, or “any combination of A, B and C”.

In the present disclosure, slash (/) or comma (,) may mean “and/or”. For example, “A/B” may mean “A and/or B”. Accordingly, “A/B” may mean “only A”, “only B”, or “both A and B”. For example, “A, B, C” may mean “A, B or C”.

In the present disclosure, “at least one of A and B” may mean “only A”, “only B” or “both A and B”. In addition, the expression “at least one of A or B” or “at least one of A and/or B” in the present disclosure may be interpreted as same as “at least one of A and B”.

In addition, in the present disclosure, “at least one of A, B and C” may mean “only A”, “only B”, “only C”, or “any combination of A, B and C”. In addition, “at least one of A, B or C” or “at least one of A, B and/or C” may mean “at least one of A, B and C”.

Also, parentheses used in the present disclosure may mean “for example”. In detail, when it is shown as “control information (PDCCH)”, “PDCCH” may be proposed as an example of “control information”. In other words, “control information” in the present disclosure is not limited to “PDCCH”, and “PDDCH” may be proposed as an example of “control information”. In addition, even when shown as “control information (i.e., PDCCH)”, “PDCCH” may be proposed as an example of “control information”.

Technical features that are separately described in one drawing in the present disclosure may be implemented separately or simultaneously.

Although not limited thereto, various descriptions, functions, procedures, suggestions, methods and/or operational flowcharts of the present disclosure disclosed herein can be applied to various fields requiring wireless communication and/or connection (e.g., 5G) between devices.

Hereinafter, the present disclosure will be described in more detail with reference to drawings. The same reference numerals in the following drawings and/or descriptions may refer to the same and/or corresponding hardware blocks, software blocks, and/or functional blocks unless otherwise indicated.

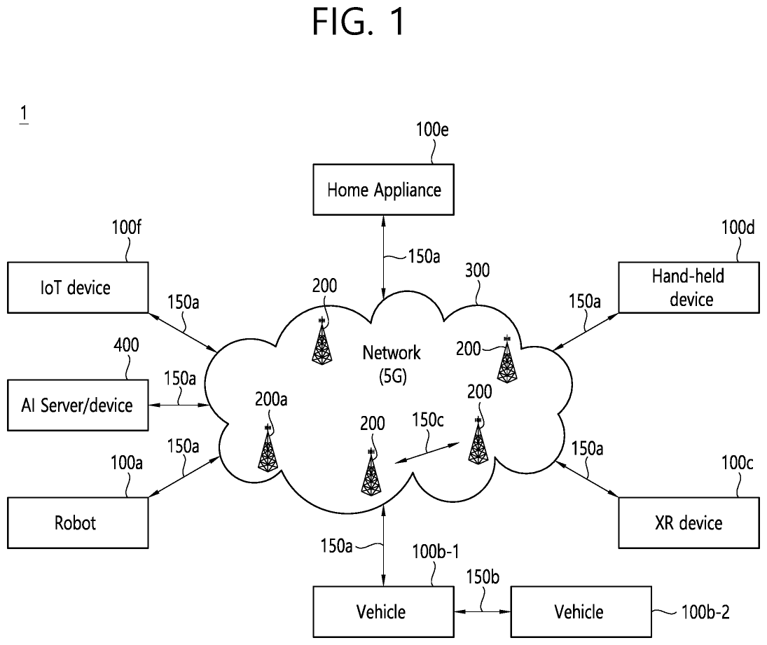

FIG. 1 shows an example of a communication system to which implementations of the present disclosure is applied.

The 5G usage scenarios shown in FIG. 1 are only exemplary, and the technical features of the present disclosure can be applied to other 5G usage scenarios which are not shown in FIG. 1.

Three main requirement categories for 5G include (1) a category of enhanced mobile broadband (eMBB), (2) a category of massive machine type communication (mMTC), and (3) a category of ultra-reliable and low latency communications (URLLC).

Partial use cases may require a plurality of categories for optimization and other use cases may focus only upon one key performance indicator (KPI). 5G supports such various use cases using a flexible and reliable method.

eMBB far surpasses basic mobile Internet access and covers abundant bidirectional work and media and entertainment applications in cloud and augmented reality. Data is one of 5G core motive forces and, in a 5G era, a dedicated voice service may not be provided for the first time. In 5G, it is expected that voice will be simply processed as an application program using data connection provided by a communication system. Main causes for increased traffic volume are due to an increase in the size of content and an increase in the number of applications requiring high data transmission rate. A streaming service (of audio and video), conversational video, and mobile Internet access will be more widely used as more devices are connected to the Internet. These many application programs require connectivity of an always turned-on state in order to push real-time information and alarm for users. Cloud storage and applications are rapidly increasing in a mobile communication platform and may be applied to both work and entertainment. The cloud storage is a special use case which accelerates growth of uplink data transmission rate. 5G is also used for remote work of cloud. When a tactile interface is used, 5G demands much lower end-to-end latency to maintain user good experience. Entertainment, for example, cloud gaming and video streaming, is another core element which increases demand for mobile broadband capability. Entertainment is essential for a smartphone and a tablet in any place including high mobility environments such as a train, a vehicle, and an airplane. Other use cases are augmented reality for entertainment and information search. In this case, the augmented reality requires very low latency and instantaneous data volume.

In addition, one of the most expected 5G use cases relates a function capable of smoothly connecting embedded sensors in all fields, i.e., mMTC. It is expected that the number of potential Internet-of-things (IoT) devices will reach 204 hundred million up to the year of 2020. An industrial IoT is one of categories of performing a main role enabling a smart city, asset tracking, smart utility, agriculture, and security infrastructure through 5G.

URLLC includes a new service that will change industry through remote control of main infrastructure and an ultra-reliable/available low-latency link such as a self-driving vehicle. A level of reliability and latency is essential to control a smart grid, automatize industry, achieve robotics, and control and adjust a drone.

5G is a means of providing streaming evaluated as a few hundred megabits per second to gigabits per second and may complement fiber-to-the-home (FTTH) and cable-based broadband (or DOCSIS). Such fast speed is needed to deliver TV in resolution of 4K or more (6K, 8K, and more), as well as virtual reality and augmented reality. Virtual reality (VR) and augmented reality (AR) applications include almost immersive sports games. A specific application program may require a special network configuration. For example, for VR games, gaming companies need to incorporate a core server into an edge network server of a network operator in order to minimize latency.

Automotive is expected to be a new important motivated force in 5G together with many use cases for mobile communication for vehicles. For example, entertainment for passengers requires high simultaneous capacity and mobile broadband with high mobility. This is because future users continue to expect connection of high quality regardless of their locations and speeds. Another use case of an automotive field is an AR dashboard. The AR dashboard causes a driver to identify an object in the dark in addition to an object seen from a front window and displays a distance from the object and a movement of the object by overlapping information talking to the driver. In the future, a wireless module enables communication between vehicles, information exchange between a vehicle and supporting infrastructure, and information exchange between a vehicle and other connected devices (e.g., devices accompanied by a pedestrian). A safety system guides alternative courses of a behavior so that a driver may drive more safely drive, thereby lowering the danger of an accident. The next stage will be a remotely controlled or self-driven vehicle. This requires very high reliability and very fast communication between different self-driven vehicles and between a vehicle and infrastructure. In the future, a self-driven vehicle will perform all driving activities and a driver will focus only upon abnormal traffic that the vehicle cannot identify. Technical requirements of a self-driven vehicle demand ultra-low latency and ultra-high reliability so that traffic safety is increased to a level that cannot be achieved by human being.

A smart city and a smart home/building mentioned as a smart society will be embedded in a high-density wireless sensor network. A distributed network of an intelligent sensor will identify conditions for costs and energy-efficient maintenance of a city or a home. Similar configurations may be performed for respective households. All of temperature sensors, window and heating controllers, burglar alarms, and home appliances are wirelessly connected. Many of these sensors are typically low in data transmission rate, power, and cost. However, real-time HD video may be demanded by a specific type of device to perform monitoring.

Consumption and distribution of energy including heat or gas is distributed at a higher level so that automated control of the distribution sensor network is demanded. The smart grid collects information and connects the sensors to each other using digital information and communication technology so as to act according to the collected information. Since this information may include behaviors of a supply company and a consumer, the smart grid may improve distribution of fuels such as electricity by a method having efficiency, reliability, economic feasibility, production sustainability, and automation. The smart grid may also be regarded as another sensor network having low latency.

Mission critical application (e.g., e-health) is one of 5G use scenarios. A health part contains many application programs capable of enjoying benefit of mobile communication. A communication system may support remote treatment that provides clinical treatment in a faraway place. Remote treatment may aid in reducing a barrier against distance and improve access to medical services that cannot be continuously available in a faraway rural area. Remote treatment is also used to perform important treatment and save lives in an emergency situation. The wireless sensor network based on mobile communication may provide remote monitoring and sensors for parameters such as heart rate and blood pressure.

Wireless and mobile communication gradually becomes important in the field of an industrial application. Wiring is high in installation and maintenance cost. Therefore, a possibility of replacing a cable with reconstructible wireless links is an attractive opportunity in many industrial fields. However, in order to achieve this replacement, it is necessary for wireless connection to be established with latency, reliability, and capacity similar to those of the cable and management of wireless connection needs to be simplified. Low latency and a very low error probability are new requirements when connection to 5G is needed.

Logistics and freight tracking are important use cases for mobile communication that enables inventory and package tracking anywhere using a location-based information system. The use cases of logistics and freight typically demand low data rate but require location information with a wide range and reliability.

Referring to FIG. 1, the communication system 1 includes wireless devices 100a to 100f, base stations (BSs) 200, and a network 300. Although FIG. 1 illustrates a 5G network as an example of the network of the communication system 1, the implementations of the present disclosure are not limited to the 5G system, and can be applied to the future communication system beyond the 5G system.

The BSs 200 and the network 300 may be implemented as wireless devices and a specific wireless device may operate as a BS/network node with respect to other wireless devices.

The wireless devices 100a to 100f represent devices performing communication using radio access technology (RAT) (e.g., 5G new RAT (NR)) or LTE) and may be referred to as communication/radio/5G devices. The wireless devices 100a to 100f may include, without being limited to, a robot 100a, vehicles 100b-1 and 100b-2, an extended reality (XR) device 100c, a hand-held device 100d, a home appliance 100e, an IoT device 100f, and an artificial intelligence (AI) device/server 400. For example, the vehicles may include a vehicle having a wireless communication function, an autonomous driving vehicle, and a vehicle capable of performing communication between vehicles. The vehicles may include an unmanned aerial vehicle (UAV) (e.g., a drone). The XR device may include an AR/VR/Mixed Reality (MR) device and may be implemented in the form of a head-mounted device (HMD), a head-up display (HUD) mounted in a vehicle, a television, a smartphone, a computer, a wearable device, a home appliance device, a digital signage, a vehicle, a robot, etc. The hand-held device may include a smartphone, a smartpad, a wearable device (e.g., a smartwatch or a smartglasses), and a computer (e.g., a notebook). The home appliance may include a TV, a refrigerator, and a washing machine. The IoT device may include a sensor and a smartmeter.

In the present disclosure, the wireless devices 100a to 100f may be called user equipments (UEs). A UE may include, for example, a cellular phone, a smartphone, a laptop computer, a digital broadcast terminal, a personal digital assistant (PDA), a portable multimedia player (PMP), a navigation system, a slate personal computer (PC), a tablet PC, an ultrabook, a vehicle, a vehicle having an autonomous traveling function, a connected car, an UAV, an AI module, a robot, an AR device, a VR device, an MR device, a hologram device, a public safety device, an MTC device, an IoT device, a medical device, a FinTech device (or a financial device), a security device, a weather/environment device, a device related to a 5G service, or a device related to a fourth industrial revolution field.

The UAV may be, for example, an aircraft aviated by a wireless control signal without a human being onboard.

The VR device may include, for example, a device for implementing an object or a background of the virtual world. The AR device may include, for example, a device implemented by connecting an object or a background of the virtual world to an object or a background of the real world. The MR device may include, for example, a device implemented by merging an object or a background of the virtual world into an object or a background of the real world. The hologram device may include, for example, a device for implementing a stereoscopic image of 360 degrees by recording and reproducing stereoscopic information, using an interference phenomenon of light generated when two laser lights called holography meet.

The public safety device may include, for example, an image relay device or an image device that is wearable on the body of a user.

The MTC device and the IoT device may be, for example, devices that do not require direct human intervention or manipulation. For example, the MTC device and the IoT device may include smartmeters, vending machines, thermometers, smartbulbs, door locks, or various sensors.

The medical device may be, for example, a device used for the purpose of diagnosing, treating, relieving, curing, or preventing disease. For example, the medical device may be a device used for the purpose of diagnosing, treating, relieving, or correcting injury or impairment. For example, the medical device may be a device used for the purpose of inspecting, replacing, or modifying a structure or a function. For example, the medical device may be a device used for the purpose of adjusting pregnancy. For example, the medical device may include a device for treatment, a device for operation, a device for (in vitro) diagnosis, a hearing aid, or a device for procedure.

The security device may be, for example, a device installed to prevent a danger that may arise and to maintain safety. For example, the security device may be a camera, a closed-circuit TV (CCTV), a recorder, or a black box.

The FinTech device may be, for example, a device capable of providing a financial service such as mobile payment. For example, the FinTech device may include a payment device or a point of sales (POS) system.

The weather/environment device may include, for example, a device for monitoring or predicting a weather/environment.

The wireless devices 100a to 100f may be connected to the network 300 via the BSs 200. An AI technology may be applied to the wireless devices 100a to 100f and the wireless devices 100a to 100f may be connected to the AI server 400 via the network 300. The network 300 may be configured using a 3G network, a 4G (e.g., LTE) network, a 5G (e.g., NR) network, and a beyond-5G network. Although the wireless devices 100a to 100f may communicate with each other through the BSs 200/network 300, the wireless devices 100a to 100f may perform direct communication (e.g., sidelink communication) with each other without passing through the BSs 200/network 300. For example, the vehicles 100b-1 and 100b-2 may perform direct communication (e.g., vehicle-to-vehicle (V2V)/vehicle-to-everything (V2X) communication). The IoT device (e.g., a sensor) may perform direct communication with other IoT devices (e.g., sensors) or other wireless devices 100a to 100f.

Wireless communication/connections 150a, 150b and 150c may be established between the wireless devices 100a to 100f and/or between wireless device 100a to 100f and BS 200 and/or between BSs 200. Herein, the wireless communication/connections may be established through various RATs (e.g., 5G NR) such as uplink/downlink communication 150a, sidelink communication (or device-to-device (D2D) communication) 150b, inter-base station communication 150c (e.g., relay, integrated access and backhaul (IAB)), etc. The wireless devices 100a to 100f and the BSs 200/the wireless devices 100a to 100f may transmit/receive radio signals to/from each other through the wireless communication/connections 150a, 150b and 150c. For example, the wireless communication/connections 150a, 150b and 150c may transmit/receive signals through various physical channels. To this end, at least a part of various configuration information configuring processes, various signal processing processes (e.g., channel encoding/decoding, modulation/demodulation, and resource mapping/de-mapping), and resource allocating processes, for transmitting/receiving radio signals, may be performed based on the various proposals of the present disclosure.

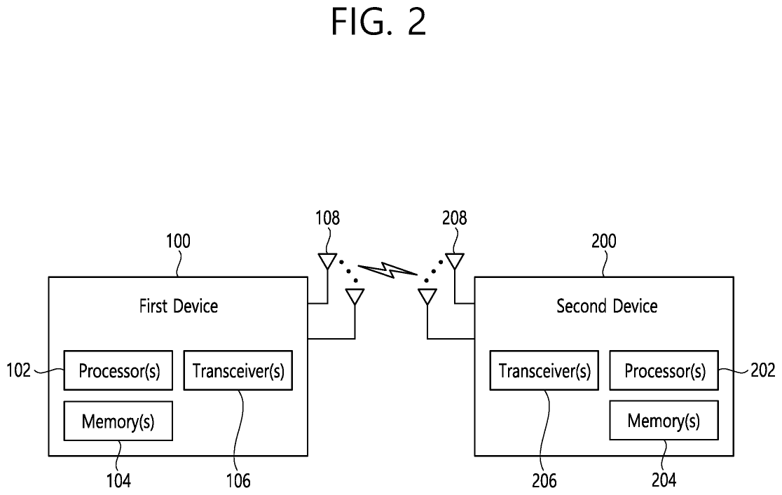

FIG. 2 shows an example of wireless devices to which implementations of the present disclosure is applied.

Referring to FIG. 2, a first wireless device 100 and a second wireless device 200 may transmit/receive radio signals to/from an external device through a variety of RATs (e.g., LTE and NR). In FIG. 2, {the first wireless device 100 and the second wireless device 200} may correspond to at least one of {the wireless device 100a to 100f and the BS 200}, {the wireless device 100a to 100f and the wireless device 100a to 100f} and/or {the BS 200 and the BS 200} of FIG. 1.

The first wireless device 100 may include one or more processors 102 and one or more memories 104 and additionally further include one or more transceivers 106 and/or one or more antennas 108. The processor(s) 102 may control the memory(s) 104 and/or the transceiver(s) 106 and may be configured to implement the descriptions, functions, procedures, suggestions, methods and/or operational flowcharts described in the present disclosure. For example, the processor(s) 102 may process information within the memory(s) 104 to generate first information/signals and then transmit radio signals including the first information/signals through the transceiver(s) 106. The processor(s) 102 may receive radio signals including second information/signals through the transceiver(s) 106 and then store information obtained by processing the second information/signals in the memory(s) 104. The memory(s) 104 may be connected to the processor(s) 102 and may store a variety of information related to operations of the processor(s) 102. For example, the memory(s) 104 may store software code including commands for performing a part or the entirety of processes controlled by the processor(s) 102 or for performing the descriptions, functions, procedures, suggestions, methods and/or operational flowcharts described in the present disclosure. Herein, the processor(s) 102 and the memory(s) 104 may be a part of a communication modem/circuit/chip designed to implement RAT (e.g., LTE or NR). The transceiver(s) 106 may be connected to the processor(s) 102 and transmit and/or receive radio signals through one or more antennas 108. Each of the transceiver(s) 106 may include a transmitter and/or a receiver. The transceiver(s) 106 may be interchangeably used with radio frequency (RF) unit(s). In the present disclosure, the first wireless device 100 may represent a communication modem/circuit/chip.

The second wireless device 200 may include one or more processors 202 and one or more memories 204 and additionally further include one or more transceivers 206 and/or one or more antennas 208. The processor(s) 202 may control the memory(s) 204 and/or the transceiver(s) 206 and may be configured to implement the descriptions, functions, procedures, suggestions, methods and/or operational flowcharts described in the present disclosure. For example, the processor(s) 202 may process information within the memory(s) 204 to generate third information/signals and then transmit radio signals including the third information/signals through the transceiver(s) 206. The processor(s) 202 may receive radio signals including fourth information/signals through the transceiver(s) 106 and then store information obtained by processing the fourth information/signals in the memory(s) 204. The memory(s) 204 may be connected to the processor(s) 202 and may store a variety of information related to operations of the processor(s) 202. For example, the memory(s) 204 may store software code including commands for performing a part or the entirety of processes controlled by the processor(s) 202 or for performing the descriptions, functions, procedures, suggestions, methods and/or operational flowcharts described in the present disclosure. Herein, the processor(s) 202 and the memory(s) 204 may be a part of a communication modem/circuit/chip designed to implement RAT (e.g., LTE or NR). The transceiver(s) 206 may be connected to the processor(s) 202 and transmit and/or receive radio signals through one or more antennas 208. Each of the transceiver(s) 206 may include a transmitter and/or a receiver. The transceiver(s) 206 may be interchangeably used with RF unit(s). In the present disclosure, the second wireless device 200 may represent a communication modem/circuit/chip.

Hereinafter, hardware elements of the wireless devices 100 and 200 will be described more specifically. One or more protocol layers may be implemented by, without being limited to, one or more processors 102 and 202. For example, the one or more processors 102 and 202 may implement one or more layers (e.g., functional layers such as physical (PHY) layer, media access control (MAC) layer, radio link control (RLC) layer, packet data convergence protocol (PDCP) layer, radio resource control (RRC) layer, and service data adaptation protocol (SDAP) layer). The one or more processors 102 and 202 may generate one or more protocol data units (PDUs) and/or one or more service data unit (SDUs) according to the descriptions, functions, procedures, suggestions, methods and/or operational flowcharts disclosed in the present disclosure. The one or more processors 102 and 202 may generate messages, control information, data, or information according to the descriptions, functions, procedures, suggestions, methods and/or operational flowcharts disclosed in the present disclosure. The one or more processors 102 and 202 may generate signals (e.g., baseband signals) including PDUs, SDUs, messages, control information, data, or information according to the descriptions, functions, procedures, suggestions, methods and/or operational flowcharts disclosed in the present disclosure and provide the generated signals to the one or more transceivers 106 and 206. The one or more processors 102 and 202 may receive the signals (e.g., baseband signals) from the one or more transceivers 106 and 206 and acquire the PDUs, SDUs, messages, control information, data, or information according to the descriptions, functions, procedures, suggestions, methods and/or operational flowcharts disclosed in the present disclosure.

The one or more processors 102 and 202 may be referred to as controllers, microcontrollers, microprocessors, or microcomputers. The one or more processors 102 and 202 may be implemented by hardware, firmware, software, or a combination thereof. As an example, one or more application specific integrated circuits (ASICs), one or more digital signal processors (DSPs), one or more digital signal processing devices (DSPDs), one or more programmable logic devices (PLDs), or one or more field programmable gate arrays (FPGAs) may be included in the one or more processors 102 and 202. descriptions, functions, procedures, suggestions, methods and/or operational flowcharts disclosed in the present disclosure may be implemented using firmware or software and the firmware or software may be configured to include the modules, procedures, or functions. Firmware or software configured to perform the descriptions, functions, procedures, suggestions, methods and/or operational flowcharts disclosed in the present disclosure may be included in the one or more processors 102 and 202 or stored in the one or more memories 104 and 204 so as to be driven by the one or more processors 102 and 202. The descriptions, functions, procedures, suggestions, methods and/or operational flowcharts disclosed in the present disclosure may be implemented using firmware or software in the form of code, commands, and/or a set of commands.

The one or more memories 104 and 204 may be connected to the one or more processors 102 and 202 and store various types of data, signals, messages, information, programs, code, instructions, and/or commands. The one or more memories 104 and 204 may be configured by read-only memories (ROMs), random access memories (RAMs), electrically erasable programmable read-only memories (EPROMs), flash memories, hard drives, registers, cash memories, computer-readable storage media, and/or combinations thereof. The one or more memories 104 and 204 may be located at the interior and/or exterior of the one or more processors 102 and 202. The one or more memories 104 and 204 may be connected to the one or more processors 102 and 202 through various technologies such as wired or wireless connection.

The one or more transceivers 106 and 206 may transmit user data, control information, and/or radio signals/channels, mentioned in the descriptions, functions, procedures, suggestions, methods and/or operational flowcharts disclosed in the present disclosure, to one or more other devices. The one or more transceivers 106 and 206 may receive user data, control information, and/or radio signals/channels, mentioned in the descriptions, functions, procedures, suggestions, methods and/or operational flowcharts disclosed in the present disclosure, from one or more other devices. For example, the one or more transceivers 106 and 206 may be connected to the one or more processors 102 and 202 and transmit and receive radio signals. For example, the one or more processors 102 and 202 may perform control so that the one or more transceivers 106 and 206 may transmit user data, control information, or radio signals to one or more other devices. The one or more processors 102 and 202 may perform control so that the one or more transceivers 106 and 206 may receive user data, control information, or radio signals from one or more other devices.

The one or more transceivers 106 and 206 may be connected to the one or more antennas 108 and 208 and the one or more transceivers 106 and 206 may be configured to transmit and receive user data, control information, and/or radio signals/channels, mentioned in the descriptions, functions, procedures, suggestions, methods and/or operational flowcharts disclosed in the present disclosure, through the one or more antennas 108 and 208. In the present disclosure, the one or more antennas may be a plurality of physical antennas or a plurality of logical antennas (e.g., antenna ports).

The one or more transceivers 106 and 206 may convert received radio signals/channels, etc., from RF band signals into baseband signals in order to process received user data, control information, radio signals/channels, etc., using the one or more processors 102 and 202. The one or more transceivers 106 and 206 may convert the user data, control information, radio signals/channels, etc., processed using the one or more processors 102 and 202 from the base band signals into the RF band signals. To this end, the one or more transceivers 106 and 206 may include (analog) oscillators and/or filters. For example, the transceivers 106 and 206 can up-convert OFDM baseband signals to a carrier frequency by their (analog) oscillators and/or filters under the control of the processors 102 and 202 and transmit the up-converted OFDM signals at the carrier frequency. The transceivers 106 and 206 may receive OFDM signals at a carrier frequency and down-convert the OFDM signals into OFDM baseband signals by their (analog) oscillators and/or filters under the control of the transceivers 102 and 202.

In the implementations of the present disclosure, a UE may operate as a transmitting device in uplink (UL) and as a receiving device in downlink (DL). In the implementations of the present disclosure, a BS may operate as a receiving device in UL and as a transmitting device in DL. Hereinafter, for convenience of description, it is mainly assumed that the first wireless device 100 acts as the UE, and the second wireless device 200 acts as the BS. For example, the processor(s) 102 connected to, mounted on or launched in the first wireless device 100 may be configured to perform the UE behavior according to an implementation of the present disclosure or control the transceiver(s) 106 to perform the UE behavior according to an implementation of the present disclosure. The processor(s) 202 connected to, mounted on or launched in the second wireless device 200 may be configured to perform the BS behavior according to an implementation of the present disclosure or control the transceiver(s) 206 to perform the BS behavior according to an implementation of the present disclosure.

In the present disclosure, a BS is also referred to as a node B (NB), an eNode B (eNB), or a gNB.

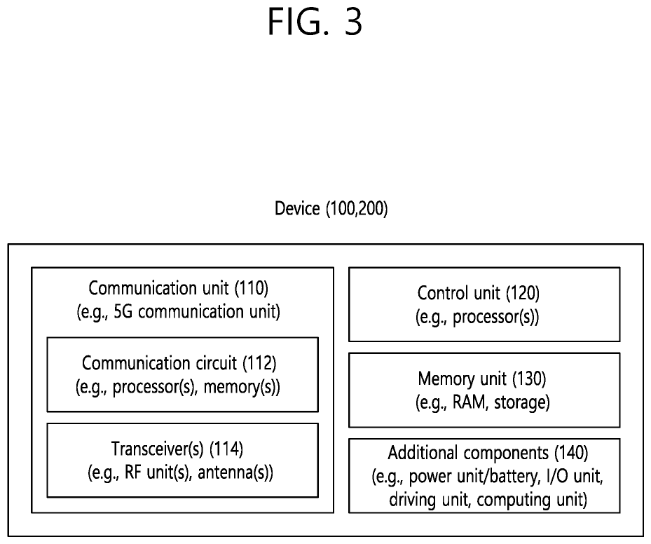

FIG. 3 shows an example of a wireless device to which implementations of the present disclosure is applied.

The wireless device may be implemented in various forms according to a use-case/service (refer to FIG. 1).

Referring to FIG. 3, wireless devices 100 and 200 may correspond to the wireless devices 100 and 200 of FIG. 2 and may be configured by various elements, components, units/portions, and/or modules. For example, each of the wireless devices 100 and 200 may include a communication unit 110, a control unit 120, a memory unit 130, and additional components 140. The communication unit 110 may include a communication circuit 112 and transceiver(s) 114. For example, the communication circuit 112 may include the one or more processors 102 and 202 of FIG. 2 and/or the one or more memories 104 and 204 of FIG. 2. For example, the transceiver(s) 114 may include the one or more transceivers 106 and 206 of FIG. 2 and/or the one or more antennas 108 and 208 of FIG. 2. The control unit 120 is electrically connected to the communication unit 110, the memory 130, and the additional components 140 and controls overall operation of each of the wireless devices 100 and 200. For example, the control unit 120 may control an electric/mechanical operation of each of the wireless devices 100 and 200 based on programs/code/commands/information stored in the memory unit 130. The control unit 120 may transmit the information stored in the memory unit 130 to the exterior (e.g., other communication devices) via the communication unit 110 through a wireless/wired interface or store, in the memory unit 130, information received through the wireless/wired interface from the exterior (e.g., other communication devices) via the communication unit 110.

The additional components 140 may be variously configured according to types of the wireless devices 100 and 200. For example, the additional components 140 may include at least one of a power unit/battery, input/output (I/O) unit (e.g., audio I/O port, video I/O port), a driving unit, and a computing unit. The wireless devices 100 and 200 may be implemented in the form of, without being limited to, the robot (100a of FIG. 1), the vehicles (100b-1 and 100b-2 of FIG. 1), the XR device (100c of FIG. 1), the hand-held device (100d of FIG. 1), the home appliance (100e of FIG. 1), the IoT device (100f of FIG. 1), a digital broadcast terminal, a hologram device, a public safety device, an MTC device, a medicine device, a FinTech device (or a finance device), a security device, a climate/environment device, the AI server/device (400 of FIG. 1), the BSs (200 of FIG. 1), a network node, etc. The wireless devices 100 and 200 may be used in a mobile or fixed place according to a use-example/service.

In FIG. 3, the entirety of the various elements, components, units/portions, and/or modules in the wireless devices 100 and 200 may be connected to each other through a wired interface or at least a part thereof may be wirelessly connected through the communication unit 110. For example, in each of the wireless devices 100 and 200, the control unit 120 and the communication unit 110 may be connected by wire and the control unit 120 and first units (e.g., 130 and 140) may be wirelessly connected through the communication unit 110. Each element, component, unit/portion, and/or module within the wireless devices 100 and 200 may further include one or more elements. For example, the control unit 120 may be configured by a set of one or more processors. As an example, the control unit 120 may be configured by a set of a communication control processor, an application processor (AP), an electronic control unit (ECU), a graphical processing unit, and a memory control processor. As another example, the memory 130 may be configured by a RAM, a DRAM, a ROM, a flash memory, a volatile memory, a non-volatile memory, and/or a combination thereof.

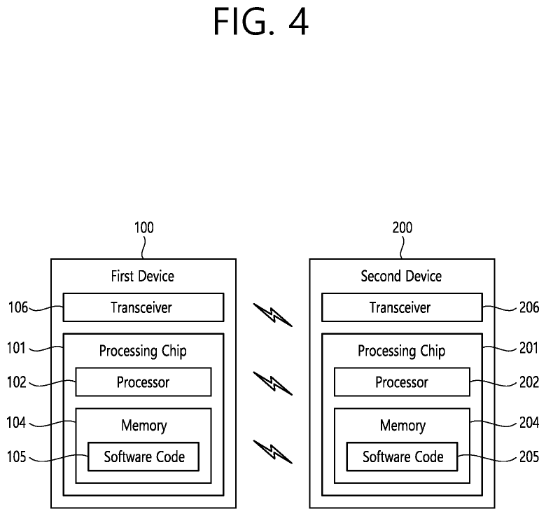

FIG. 4 shows another example of wireless devices to which implementations of the present disclosure is applied.

Referring to FIG. 4, wireless devices 100 and 200 may correspond to the wireless devices 100 and 200 of FIG. 2 and may be configured by various elements, components, units/portions, and/or modules.

The first wireless device 100 may include at least one transceiver, such as a transceiver 106, and at least one processing chip, such as a processing chip 101. The processing chip 101 may include at least one processor, such a processor 102, and at least one memory, such as a memory 104. The memory 104 may be operably connectable to the processor 102. The memory 104 may store various types of information and/or instructions. The memory 104 may store a software code 105 which implements instructions that, when executed by the processor 102, perform the descriptions, functions, procedures, suggestions, methods and/or operational flowcharts disclosed in the present disclosure. For example, the software code 105 may implement instructions that, when executed by the processor 102, perform the descriptions, functions, procedures, suggestions, methods and/or operational flowcharts disclosed in the present disclosure. For example, the software code 105 may control the processor 102 to perform one or more protocols. For example, the software code 105 may control the processor 102 may perform one or more layers of the radio interface protocol.

The second wireless device 200 may include at least one transceiver, such as a transceiver 206, and at least one processing chip, such as a processing chip 201. The processing chip 201 may include at least one processor, such a processor 202, and at least one memory, such as a memory 204. The memory 204 may be operably connectable to the processor 202. The memory 204 may store various types of information and/or instructions. The memory 204 may store a software code 205 which implements instructions that, when executed by the processor 202, perform the descriptions, functions, procedures, suggestions, methods and/or operational flowcharts disclosed in the present disclosure. For example, the software code 205 may implement instructions that, when executed by the processor 202, perform the descriptions, functions, procedures, suggestions, methods and/or operational flowcharts disclosed in the present disclosure. For example, the software code 205 may control the processor 202 to perform one or more protocols. For example, the software code 205 may control the processor 202 may perform one or more layers of the radio interface protocol.

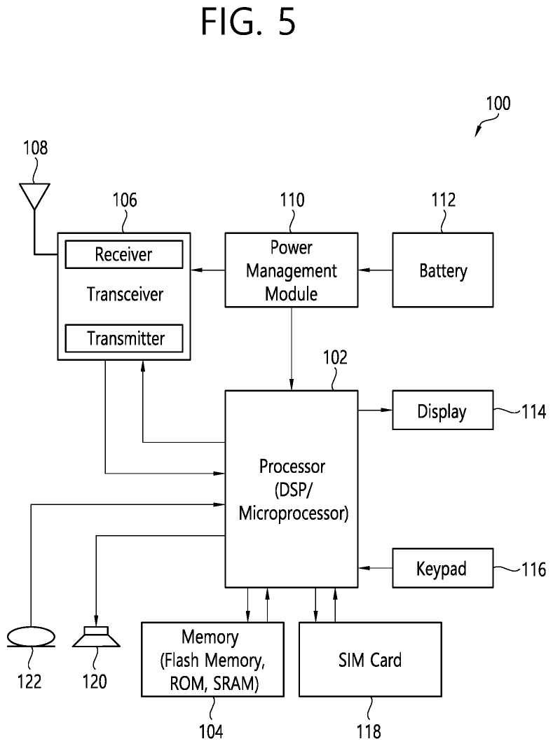

FIG. 5 shows an example of UE to which implementations of the present disclosure is applied.

Referring to FIG. 5, a UE 100 may correspond to the first wireless device 100 of FIG. 2 and/or the first wireless device 100 of FIG. 4.

A UE 100 includes a processor 102, a memory 104, a transceiver 106, one or more antennas 108, a power management module 110, a battery 1112, a display 114, a keypad 116, a subscriber identification module (SIM) card 118, a speaker 120, and a microphone 122.

The processor 102 may be configured to implement the descriptions, functions, procedures, suggestions, methods and/or operational flowcharts disclosed in the present disclosure. The processor 102 may be configured to control one or more other components of the UE 100 to implement the descriptions, functions, procedures, suggestions, methods and/or operational flowcharts disclosed in the present disclosure. Layers of the radio interface protocol may be implemented in the processor 102. The processor 102 may include ASIC, other chipset, logic circuit and/or data processing device. The processor 102 may be an application processor. The processor 102 may include at least one of a digital signal processor (DSP), a central processing unit (CPU), a graphics processing unit (GPU), a modem (modulator and demodulator). An example of the processor 102 may be found in SNAPDRAGON™ series of processors made by Qualcomm®, EXYNOS™ series of processors made by Samsung®, A series of processors made by Apple®, HELIO™ series of processors made by MediaTek®, ATOM™ series of processors made by Intel® or a corresponding next generation processor.

The memory 104 is operatively coupled with the processor 102 and stores a variety of information to operate the processor 102. The memory 104 may include ROM, RAM, flash memory, memory card, storage medium and/or other storage device. When the embodiments are implemented in software, the techniques described herein can be implemented with modules (e.g., procedures, functions, etc.) that perform the descriptions, functions, procedures, suggestions, methods and/or operational flowcharts disclosed in the present disclosure. The modules can be stored in the memory 104 and executed by the processor 102. The memory 104 can be implemented within the processor 102 or external to the processor 102 in which case those can be communicatively coupled to the processor 102 via various means as is known in the art.

The transceiver 106 is operatively coupled with the processor 102, and transmits and/or receives a radio signal. The transceiver 106 includes a transmitter and a receiver. The transceiver 106 may include baseband circuitry to process radio frequency signals. The transceiver 106 controls the one or more antennas 108 to transmit and/or receive a radio signal.

The power management module 110 manages power for the processor 102 and/or the transceiver 106. The battery 112 supplies power to the power management module 110.

The display 114 outputs results processed by the processor 102. The keypad 116 receives inputs to be used by the processor 102. The keypad 16 may be shown on the display 114.

The SIM card 118 is an integrated circuit that is intended to securely store the international mobile subscriber identity (IMSI) number and its related key, which are used to identify and authenticate subscribers on mobile telephony devices (such as mobile phones and computers). It is also possible to store contact information on many SIM cards.

The speaker 120 outputs sound-related results processed by the processor 102. The microphone 122 receives sound-related inputs to be used by the processor 102.

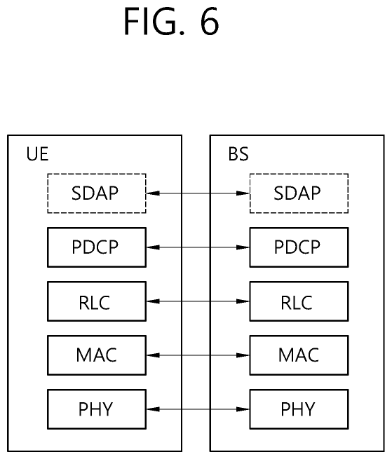

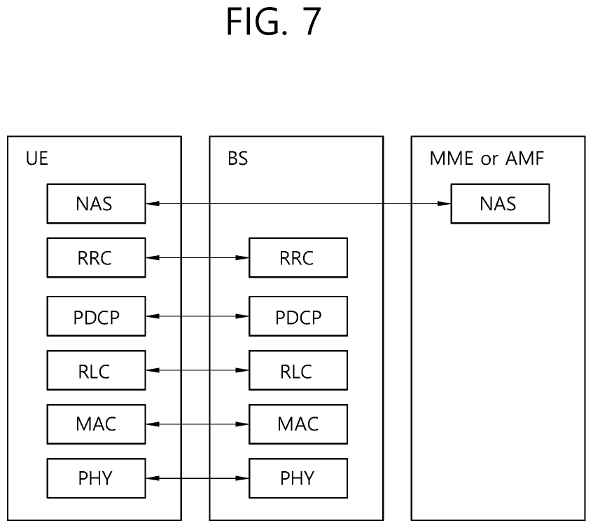

FIGS. 6 and 7 show an example of protocol stacks in a 3GPP based wireless communication system to which implementations of the present disclosure is applied.

In particular, FIG. 6 illustrates an example of a radio interface user plane protocol stack between a UE and a BS and FIG. 7 illustrates an example of a radio interface control plane protocol stack between a UE and a BS. The control plane refers to a path through which control messages used to manage call by a UE and a network are transported. The user plane refers to a path through which data generated in an application layer, for example, voice data or Internet packet data are transported. Referring to FIG. 6, the user plane protocol stack may be divided into Layer 1 (i.e., a PHY layer) and Layer 2. Referring to FIG. 7, the control plane protocol stack may be divided into Layer 1 (i.e., a PHY layer), Layer 2, Layer 3 (e.g., an RRC layer), and a non-access stratum (NAS) layer. Layer 1, Layer 2 and Layer 3 are referred to as an access stratum (AS).

In the 3GPP LTE system, the Layer 2 is split into the following sublayers: MAC, RLC, and PDCP. In the 3GPP NR system, the Layer 2 is split into the following sublayers: MAC, RLC, PDCP and SDAP. The PHY layer offers to the MAC sublayer transport channels, the MAC sublayer offers to the RLC sublayer logical channels, the RLC sublayer offers to the PDCP sublayer RLC channels, the PDCP sublayer offers to the SDAP sublayer radio bearers. The SDAP sublayer offers to 5G core network quality of service (QoS) flows.

In the 3GPP NR system, the main services and functions of the MAC sublayer include: mapping between logical channels and transport channels; multiplexing/de-multiplexing of MAC SDUs belonging to one or different logical channels into/from transport blocks (TB) delivered to/from the physical layer on transport channels; scheduling information reporting; error correction through hybrid automatic repeat request (HARQ) (one HARQ entity per cell in case of carrier aggregation (CA)); priority handling between UEs by means of dynamic scheduling; priority handling between logical channels of one UE by means of logical channel prioritization; padding. A single MAC entity may support multiple numerologies, transmission timings and cells. Mapping restrictions in logical channel prioritization control which numerology(ies), cell(s), and transmission timing(s) a logical channel can use.

Different kinds of data transfer services are offered by MAC. To accommodate different kinds of data transfer services, multiple types of logical channels are defined, i.e., each supporting transfer of a particular type of information. Each logical channel type is defined by what type of information is transferred. Logical channels are classified into two groups: control channels and traffic channels. Control channels are used for the transfer of control plane information only, and traffic channels are used for the transfer of user plane information only. Broadcast control channel (BCCH) is a downlink logical channel for broadcasting system control information, paging control channel (PCCH) is a downlink logical channel that transfers paging information, system information change notifications and indications of ongoing public warning service (PWS) broadcasts, common control channel (CCCH) is a logical channel for transmitting control information between UEs and network and used for UEs having no RRC connection with the network, and dedicated control channel (DCCH) is a point-to-point bi-directional logical channel that transmits dedicated control information between a UE and the network and used by UEs having an RRC connection. Dedicated traffic channel (DTCH) is a point-to-point logical channel, dedicated to one UE, for the transfer of user information. A DTCH can exist in both uplink and downlink. In downlink, the following connections between logical channels and transport channels exist: BCCH can be mapped to broadcast channel (BCH); BCCH can be mapped to downlink shared channel (DL-SCH); PCCH can be mapped to paging channel (PCH); CCCH can be mapped to DL-SCH; DCCH can be mapped to DL-SCH; and DTCH can be mapped to DL-SCH. In uplink, the following connections between logical channels and transport channels exist: CCCH can be mapped to uplink shared channel (UL-SCH); DCCH can be mapped to UL-SCH; and DTCH can be mapped to UL-SCH.

The RLC sublayer supports three transmission modes: transparent mode (TM), unacknowledged mode (UM), and acknowledged node (AM). The RLC configuration is per logical channel with no dependency on numerologies and/or transmission durations. In the 3GPP NR system, the main services and functions of the RLC sublayer depend on the transmission mode and include: transfer of upper layer PDUs; sequence numbering independent of the one in PDCP (UM and AM); error correction through ARQ (AM only); segmentation (AM and UM) and re-segmentation (AM only) of RLC SDUs; reassembly of SDU (AM and UM); duplicate detection (AM only); RLC SDU discard (AM and UM); RLC re-establishment; protocol error detection (AM only).

In the 3GPP NR system, the main services and functions of the PDCP sublayer for the user plane include: sequence numbering; header compression and decompression using robust header compression (ROHC); transfer of user data; reordering and duplicate detection; in-order delivery; PDCP PDU routing (in case of split bearers); retransmission of PDCP SDUs; ciphering, deciphering and integrity protection; PDCP SDU discard; PDCP re-establishment and data recovery for RLC AM; PDCP status reporting for RLC AM; duplication of PDCP PDUs and duplicate discard indication to lower layers. The main services and functions of the PDCP sublayer for the control plane include: sequence numbering; ciphering, deciphering and integrity protection; transfer of control plane data; reordering and duplicate detection; in-order delivery; duplication of PDCP PDUs and duplicate discard indication to lower layers.

In the 3GPP NR system, the main services and functions of SDAP include: mapping between a QoS flow and a data radio bearer; marking QoS flow ID (QFI) in both DL and UL packets. A single protocol entity of SDAP is configured for each individual PDU session.

In the 3GPP NR system, the main services and functions of the RRC sublayer include: broadcast of system information related to AS and NAS; paging initiated by 5GC or NG-RAN; establishment, maintenance and release of an RRC connection between the UE and NG-RAN; security functions including key management; establishment, configuration, maintenance and release of signaling radio bearers (SRBs) and data radio bearers (DRBs); mobility functions (including: handover and context transfer, UE cell selection and reselection and control of cell selection and reselection, inter-RAT mobility); QoS management functions; UE measurement reporting and control of the reporting; detection of and recovery from radio link failure; NAS message transfer to/from NAS from/to UE.

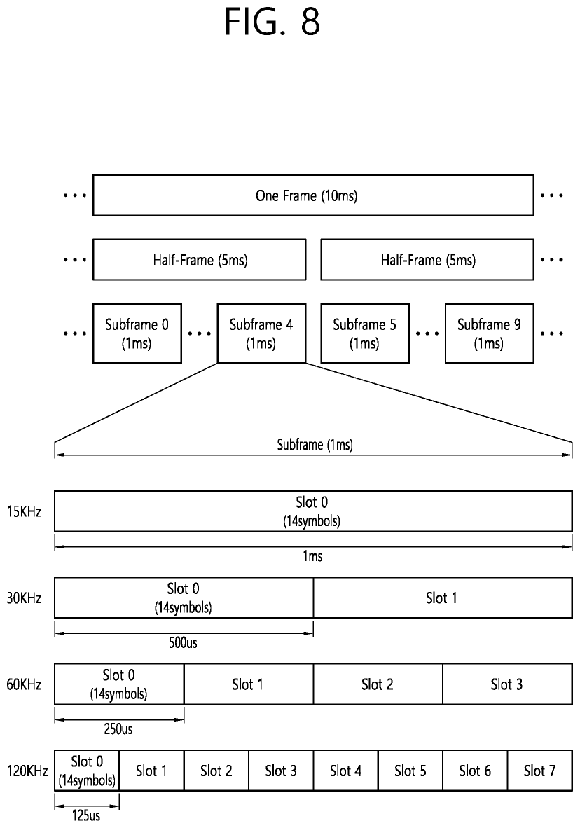

FIG. 8 shows a frame structure in a 3GPP based wireless communication system to which implementations of the present disclosure is applied.

The frame structure shown in FIG. 8 is purely exemplary and the number of subframes, the number of slots, and/or the number of symbols in a frame may be variously changed. In the 3GPP based wireless communication system, OFDM numerologies (e.g., subcarrier spacing (SCS), transmission time interval (TTI) duration) may be differently configured between a plurality of cells aggregated for one UE. For example, if a UE is configured with different SCSs for cells aggregated for the cell, an (absolute time) duration of a time resource (e.g., a subframe, a slot, or a TTI) including the same number of symbols may be different among the aggregated cells. Herein, symbols may include OFDM symbols (or CP-OFDM symbols), SC-FDMA symbols (or discrete Fourier transform-spread-OFDM (DFT-s-OFDM) symbols).

Referring to FIG. 8, downlink and uplink transmissions are organized into frames. Each frame has T_{f}=10 ms duration. Each frame is divided into two half-frames, where each of the half-frames has 5 ms duration. Each half-frame consists of 5 subframes, where the duration T_{sf} per subframe is 1 ms. Each subframe is divided into slots and the number of slots in a subframe depends on a subcarrier spacing. Each slot includes 14 or 12 OFDM symbols based on a cyclic prefix (CP). In a normal CP, each slot includes 14 OFDM symbols and, in an extended CP, each slot includes 12 OFDM symbols. The numerology is based on exponentially scalable subcarrier spacing Δf=2^{u}*15 kHz.

Table 1 shows the number of OFDM symbols per slot N^{slot}_{symb}, the number of slots per frame N^{frame,u}ₛₗₒₜ, and the number of slots per subframe N^{subframe,u}ₛₗₒₜ for the normal CP, according to the subcarrier spacing Δf=2^{u}*15 kHz.

TABLE 1

| u | N^{slot}_{symb} | N^{frame, u}ₛₗₒₜ | N^{subframe, u}ₛₗₒₜ |
|---|---|---|---|
| 0 | 14 | 10 | 1 |
| 1 | 14 | 20 | 2 |
| 2 | 14 | 40 | 4 |
| 3 | 14 | 80 | 8 |
| 4 | 14 | 160 | 16 |

Table 2 shows the number of OFDM symbols per slot N^{slot}_{symb}, the number of slots per frame N^{frame,u}ₛₗₒₜ, and the number of slots per subframe N^{subframe,u}ₛₗₒₜ for the extended CP, according to the subcarrier spacing Δf=2^{u}*15 kHz.

TABLE 2

| u | N^{slot}_{symb} | N^{frame, u}ₛₗₒₜ | N^{subframe, u}ₛₗₒₜ |
|---|---|---|---|
| 2 | 12 | 40 | 4 |

A slot includes plural symbols (e.g., 14 or 12 symbols) in the time domain. For each numerology (e.g., subcarrier spacing) and carrier, a resource grid of N^{size,u}_{grid}*N^{RB}_{sc} subcarriers and N^{subframe,u}_{symb} OFDM symbols is defined, starting at common resource block (CRB) N^{start,u}_{grid} indicated by higher-layer signaling (e.g., RRC signaling), where N^{size,u}_{grid,x} is the number of resource blocks (RBs) in the resource grid and the subscript x is DL for downlink and UL for uplink. N^{RB}_{sc} is the number of subcarriers per RB. In the 3GPP based wireless communication system, N^{RB}_{sc} is 12 generally. There is one resource grid for a given antenna port p, subcarrier spacing configuration u, and transmission direction (DL or UL). The carrier bandwidth N^{size,u}_{grid} for subcarrier spacing configuration u is given by the higher-layer parameter (e.g., RRC parameter). Each element in the resource grid for the antenna port p and the subcarrier spacing configuration u is referred to as a resource element (RE) and one complex symbol may be mapped to each RE. Each RE in the resource grid is uniquely identified by an index k in the frequency domain and an index/representing a symbol location relative to a reference point in the time domain. In the 3GPP based wireless communication system, an RB is defined by 12 consecutive subcarriers in the frequency domain.

In the 3GPP NR system, RBs are classified into CRBs and physical resource blocks (PRBs). CRBs are numbered from 0 and upwards in the frequency domain for subcarrier spacing configuration u. The center of subcarrier 0 of CRB 0 for subcarrier spacing configuration u coincides with ‘point A’ which serves as a common reference point for resource block grids. In the 3GPP NR system, PRBs are defined within a bandwidth part (BWP) and numbered from 0 to N^{size}_{BWP,i}−1, where i is the number of the bandwidth part. The relation between the physical resource block n_{PRB} in the bandwidth part i and the common resource block n_{CRB} is as follows: n_{PRB}=n_{CRB} N^{size}_{BWP,i}, where N^{size}_{BWP,i} is the common resource block where bandwidth part starts relative to CRB 0. The BWP includes a plurality of consecutive RBs. A carrier may include a maximum of N (e.g., 5) BWPs. A UE may be configured with one or more BWPs on a given component carrier. Only one BWP among BWPs configured to the UE can active at a time. The active BWP defines the UE's operating bandwidth within the cell's operating bandwidth.

The NR frequency band may be defined as two types of frequency range, i.e., FR1 and FR2. The numerical value of the frequency range may be changed. For example, the frequency ranges of the two types (FR1 and FR2) may be as shown in Table 3 below. For ease of explanation, in the frequency ranges used in the NR system, FR1 may mean “sub 6 GHz range”, FR2 may mean “above 6 GHz range,” and may be referred to as millimeter wave (mmW).

TABLE 3

| Frequency Range | Corresponding | Subcarrier |
|---|---|---|
| designation | frequency range | Spacing |
| FR1 | 450 MHz-6000 MHz | 15, 30, 60 kHz |
| FR2 | 24250 MHz-52600 MHz | 60, 120, 240 kHz |

As mentioned above, the numerical value of the frequency range of the NR system may be changed. For example, FR1 may include a frequency band of 410 MHz to 7125 MHz as shown in Table 4 below. That is, FR1 may include a frequency band of 6 GHz (or 5850, 5900, 5925 MHz, etc.) or more. For example, a frequency band of 6 GHz (or 5850, 5900, 5925 MHz, etc.) or more included in FR1 may include an unlicensed band. Unlicensed bands may be used for a variety of purposes, for example for communication for vehicles (e.g., autonomous driving).

TABLE 4

| Frequency Range | Corresponding | Subcarrier |
|---|---|---|
| designation | frequency range | Spacing |
| FR1 | 410 MHz-7125 MHz | 15, 30, 60 kHz |
| FR2 | 24250 MHz-52600 MHz | 60, 120, 240 kHz |

In the present disclosure, the term “cell” may refer to a geographic area to which one or more nodes provide a communication system, or refer to radio resources. A “cell” as a geographic area may be understood as coverage within which a node can provide service using a carrier and a “cell” as radio resources (e.g., time-frequency resources) is associated with bandwidth which is a frequency range configured by the carrier. The “cell” associated with the radio resources is defined by a combination of downlink resources and uplink resources, for example, a combination of a DL component carrier (CC) and a UL CC. The cell may be configured by downlink resources only, or may be configured by downlink resources and uplink resources. Since DL coverage, which is a range within which the node is capable of transmitting a valid signal, and UL coverage, which is a range within which the node is capable of receiving the valid signal from the UE, depends upon a carrier carrying the signal, the coverage of the node may be associated with coverage of the “cell” of radio resources used by the node. Accordingly, the term “cell” may be used to represent service coverage of the node sometimes, radio resources at other times, or a range that signals using the radio resources can reach with valid strength at other times.

In CA, two or more CCs are aggregated. A UE may simultaneously receive or transmit on one or multiple CCs depending on its capabilities. CA is supported for both contiguous and non-contiguous CCs. When CA is configured, the UE only has one RRC connection with the network. At RRC connection establishment/re-establishment/handover, one serving cell provides the NAS mobility information, and at RRC connection re-establishment/handover, one serving cell provides the security input. This cell is referred to as the primary cell (PCell). The PCell is a cell, operating on the primary frequency, in which the UE either performs the initial connection establishment procedure or initiates the connection re-establishment procedure. Depending on UE capabilities, secondary cells (SCells) can be configured to form together with the PCell a set of serving cells. An SCell is a cell providing additional radio resources on top of special cell (SpCell). The configured set of serving cells for a UE therefore always consists of one PCell and one or more SCells. For dual connectivity (DC) operation, the term SpCell refers to the PCell of the master cell group (MCG) or the primary SCell (PSCell) of the secondary cell group (SCG). An SpCell supports PUCCH transmission and contention-based random access, and is always activated. The MCG is a group of serving cells associated with a master node, comprised of the SpCell (PCell) and optionally one or more SCells. The SCG is the subset of serving cells associated with a secondary node, comprised of the PSCell and zero or more SCells, for a UE configured with DC. For a UE in RRC_CONNECTED not configured with CA/DC, there is only one serving cell comprised of the PCell. For a UE in RRC_CONNECTED configured with CA/DC, the term “serving cells” is used to denote the set of cells comprised of the SpCell(s) and all SCells. In DC, two MAC entities are configured in a UE: one for the MCG and one for the SCG.

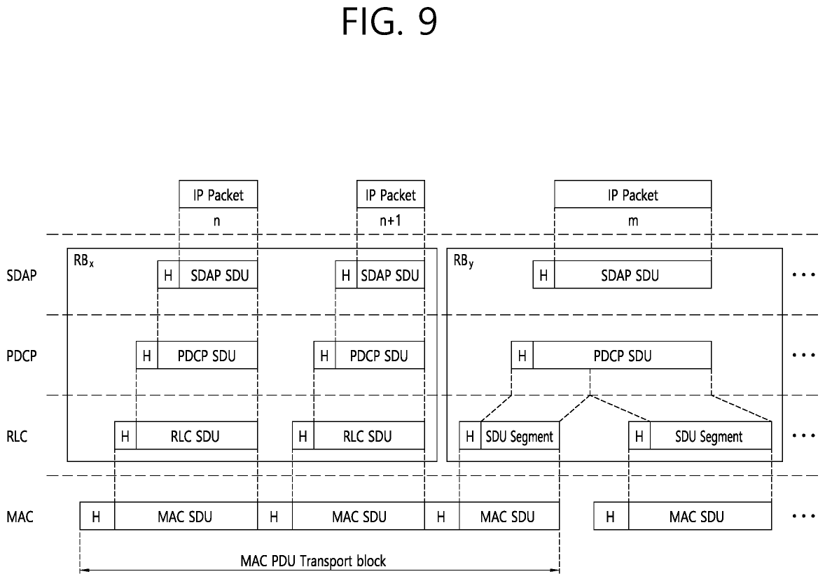

FIG. 9 shows a data flow example in the 3GPP NR system to which implementations of the present disclosure is applied.

Referring to FIG. 9, “RB” denotes a radio bearer, and “H” denotes a header. Radio bearers are categorized into two groups: DRBs for user plane data and SRBs for control plane data. The MAC PDU is transmitted/received using radio resources through the PHY layer to/from an external device. The MAC PDU arrives to the PHY layer in the form of a transport block.

In the PHY layer, the uplink transport channels UL-SCH and RACH are mapped to their physical channels physical uplink shared channel (PUSCH) and physical random access channel (PRACH), respectively, and the downlink transport channels DL-SCH, BCH and PCH are mapped to physical downlink shared channel (PDSCH), physical broadcast channel (PBCH) and PDSCH, respectively. In the PHY layer, uplink control information (UCI) is mapped to physical uplink control channel (PUCCH), and downlink control information (DCI) is mapped to physical downlink control channel (PDCCH). A MAC PDU related to UL-SCH is transmitted by a UE via a PUSCH based on an UL grant, and a MAC PDU related to DL-SCH is transmitted by a BS via a PDSCH based on a DL assignment.

Cell search is the procedure by which a UE acquires time and frequency synchronization with a cell and detects the cell ID of that cell. NR cell search is based on the primary synchronization signal (PSS) and secondary synchronization signal (SSS), and PBCH demodulation reference signal (DM-RS), located on the synchronization raster.

The cell search procedure of the UE can be summarized in Table 5.

TABLE 5

| | Type of Signals | Operations |
|---|---|---|
| 1^{st} step | PSS | * SS/PBCH block (SSB) |
| | | symbol timing acquisition |
| | | * Cell ID detection within |
| | | a cell ID group (3 hypothesis) |
| 2^{nd} Step | SSS | * Cell ID group detection |
| | | (336 hypothesis) |
| 3^{rd} Step | PBCH DM-RS | * SSB index and Half frame |
| | | index(Slot and frame |
| | | boundary detection) |
| 4^{th} Step | PBCH | * Time information |
| | | (80 ms, SFN, SSB index, HF) |
| | | * RMSI CORESET/Search |
| | | space configuration |
| 5^{th} Step | PDCCH and PDSCH | * Cell access information |
| | | * RACH configuration |

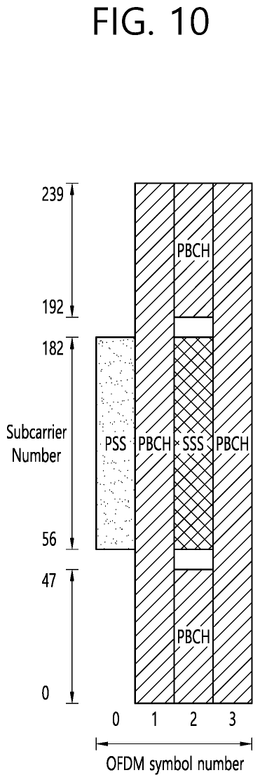

FIG. 10 shows an example of SSB to which implementations of the present disclosure is applied.

The SSB consists of PSS and SSS, each occupying 1 symbol and 127 subcarriers, and PBCH spanning across 3 OFDM symbols and 240 subcarriers, but on one symbol leaving an unused part in the middle for SSS. The possible time locations of SSBs within a half-frame are determined by subcarrier spacing and the periodicity of the half-frames where SSBs are transmitted is configured by the network. During a half-frame, different SSBs may be transmitted in different spatial directions (i.e. using different beams, spanning the coverage area of a cell).

Within the frequency span of a carrier, multiple SSBs can be transmitted. The physical cell IDs (PCIs) of SSBs transmitted in different frequency locations do not have to be unique, i.e., different SSBs in the frequency domain can have different PCIs. However, when an SSB is associated with a remaining minimum system information (RMSI), the SSB corresponds to an individual cell, which has a unique NR cell global identity (NCGI). Such an SSB is referred to as a cell-defining SSB (CD-SSB). A PCell is always associated to a CD-SSB located on the synchronization raster.

Polar coding is used for PBCH.

The UE may assume a band-specific subcarrier spacing for the SSB unless a network has configured the UE to assume a different sub-carrier spacing.

PBCH symbols carry its own frequency-multiplexed DM-RS.

Quadrature phase shift keying (QPSK) modulation is used for PBCH.

System information (SI) consists of a master information block (MIB) and a number of system information blocks (SIBs), which are divided into minimum SI and other SI.

(1) Minimum SI comprises basic information required for initial access and information for acquiring any other SI. Minimum SI consists of:
MIB contains cell barred status information and essential physical layer information of the cell required to receive further system information (e.g., SIB1), e.g. CORESET #0 configuration. MIB is always periodically broadcast on BCH with a periodicity of 80 ms and repetitions made within 80 ms. The first transmission of the MIB is scheduled in subframes as defined above for SS/PBCH block and repetitions are scheduled according to the period of SSB.
SIB1 defines the availability and the scheduling of other system information blocks (e.g., mapping of SIBs to SI message, periodicity, SI-window size) with an indication whether one or more SIBs are only provided on-demand and, in that case, the configuration needed by the UE to perform the SI request and contains information required for initial access. SIB1 is also referred to as RMSI and is periodically broadcast on DL-SCH or sent in a dedicated manner on DL-SCH to UEs in RRC_CONNECTED, with a periodicity of 160 ms and variable transmission repetition periodicity within 160 ms. The default transmission repetition periodicity of SIB1 is 20 ms but the actual transmission repetition periodicity is up to network implementation. For SSB and CORESET multiplexing pattern 1, SIB1 repetition transmission period is 20 ms. For SSB and CORESET multiplexing pattern 2/3, SIB1 transmission repetition period is the same as the SSB period. SIB1 is cell-specific SIB.

(2) Other SI encompasses all SIBs not broadcast in the minimum SI. Those SIBs can either be periodically broadcast on DL-SCH, broadcast on-demand on DL-SCH (i.e., upon request from UEs in RRC_IDLE or RRC_INACTIVE), or sent in a dedicated manner on DL-SCH to UEs in RRC_CONNECTED. SIBs in other SI are carried in SystemInformation (SI) messages. Only SIBs having the same periodicity can be mapped to the same SI message. Each SI message is transmitted within periodically occurring time domain windows (referred to as SI-windows with same length for all SI messages). Each SI message is associated with an SI-window and the SI-windows of different SI messages do not overlap. That is, within one SI-window only the corresponding SI message is transmitted. An SI message may be transmitted a number of times within the SI-window. Any SIB except SIB1 can be configured to be cell specific or area specific, using an indication in SIB1. The cell specific SIB is applicable only within a cell that provides the SIB while the area specific SIB is applicable within an area referred to as SI area, which consists of one or several cells and is identified by systemInformationAreaID. Other SI consists of:
SIB2 contains cell re-selection information, mainly related to the serving cell;
SIB3 contains information about the serving frequency and intra-frequency neighbouring cells relevant for cell re-selection (including cell re-selection parameters common for a frequency as well as cell specific re-selection parameters);
SIB4 contains information about other NR frequencies and inter-frequency neighbouring cells relevant for cell re-selection (including cell re-selection parameters common for a frequency as well as cell specific re-selection parameters);
SIB5 contains information about E-UTRA frequencies and E-UTRA neighbouring cells relevant for cell re-selection (including cell re-selection parameters common for a frequency as well as cell specific re-selection parameters);
SIB6 contains an earthquake and tsunami warning system (ETWS) primary notification;
SIB7 contains an ETWS secondary notification;
SIB8 contains a commercial mobile alert system (CMAS) warning notification;
SIB9 contains information related to global positioning system (GPS) time and coordinated universal Time (UTC).

For a UE in RRC_CONNECTED, the network can provide system information through dedicated signaling using the RRCReconfiguration message, e.g. if the UE has an active BWP with no common search space configured to monitor system information or paging.

For PSCell and SCells, the network provides the required SI by dedicated signaling, i.e., within an RRCReconfiguration message. Nevertheless, the UE shall acquire MIB of the PSCell to get system frame number (SFN) timing of the SCG (which may be different from MCG). Upon change of relevant SI for SCell, the network releases and adds the concerned SCell. For PSCell, the required SI can only be changed with Reconfiguration with Sync.

The physical layer imposes a limit to the maximum size a SIB can take. The maximum SIB1 or SI message size is 2976 bits.

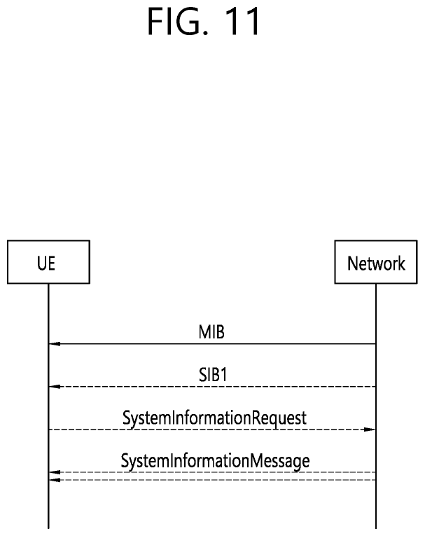

FIG. 11 shows an example of SI acquisition procedure to which implementations of the present disclosure is applied.

The UE applies the SI acquisition procedure to acquire the AS and NAS information. The procedure applies to UEs in RRC_IDLE, in RRC_INACTIVE and in RRC_CONNECTED.

The UE in RRC_IDLE and RRC_INACTIVE shall ensure having a valid version of (at least) the MIB, SIB1 through SIB4 and SIB5 (if the UE supports E-UTRA).

For a cell/frequency that is considered for camping by the UE, the UE is not required to acquire the contents of the minimum SI of that cell/frequency from another cell/frequency layer. This does not preclude the case that the UE applies stored SI from previously visited cell(s).

If the UE cannot determine the full contents of the minimum SI of a cell by receiving from that cell, the UE shall consider that cell as barred.

In case of bandwidth adaptation (BA), the UE only acquires SI on the active BWP.

For UEs in RRC_IDLE and RRC_INACTIVE, a request for other SI triggers a random access procedure where MSG3 includes the SI request message unless the requested SI is associated to a subset of the PRACH resources, in which case MSG1 is used for indication of the requested other SI. When MSG1 is used, the minimum granularity of the request is one SI message (i.e., a set of SIBs), one RACH preamble and/or PRACH resource can be used to request multiple SI messages and the gNB acknowledges the request in MSG2. When MSG 3 is used, the gNB acknowledges the request in MSG4.

The other SI may be broadcast at a configurable periodicity and for a certain duration. The other SI may also be broadcast when it is requested by UE in RRC_IDLE/RRC_INACTIVE.

For a UE to be allowed to camp on a cell it must have acquired the contents of the minimum SI from that cell. There may be cells in the system that do not broadcast the minimum SI and where the UE therefore cannot camp.

Change of system information (other than for ETWS/CMAS4) only occurs at specific radio frames, i.e., the concept of a modification period is used. System information may be transmitted a number of times with the same content within a modification period, as defined by its scheduling. The modification period is configured by system information.

When the network changes (some of the) system information, it first notifies the UEs about this change, i.e., this may be done throughout a modification period. In the next modification period, the network transmits the updated system information. Upon receiving a change notification, the UE acquires the new system information from the start of the next modification period. The UE applies the previously acquired system information until the UE acquires the new system information.

The random access procedure of the UE can be summarized in Table 6.

TABLE 6

| | Type of Signals | Operations/Information Acquired |
|---|---|---|
| 1^{st} step | PRACH preamble in | * Initial beam acquisition |
| | UL | * Random election of |
| | | RA-preamble ID |
| 2^{nd} Step | Random Access | * Timing alignment information |
| | Response on DL-SCH | * RA-preamble ID |
| | | * Initial UL grant, Temporary |
| | | C-RNTI |
| 3^{rd} Step | UL transmission | * RRC connection request |
| | on UL-SCH | * UE identifier |
| 4^{th} Step | Contention Resolution | * Temporary C-RNTI on PDCCH for |
| | on DL | initial access |
| | | * C-RNTI on PDCCH for UE in |
| | | RRC_CONNECTED |

The random access procedure is triggered by a number of events:—Initial access from RRC_IDLE;
RRC connection re-establishment procedure;
DL or UL data arrival during RRC_CONNECTED when UL synchronization status is “non-synchronized”;
UL data arrival during RRC_CONNECTED when there are no PUCCH resources for scheduling request (SR) available;
SR failure;
Request by RRC upon synchronous reconfiguration (e.g., handover);
Transition from RRC_INACTIVE;
To establish time alignment for a secondary timing advance group (TAG);
Request for other SI;
Beam failure recovery.

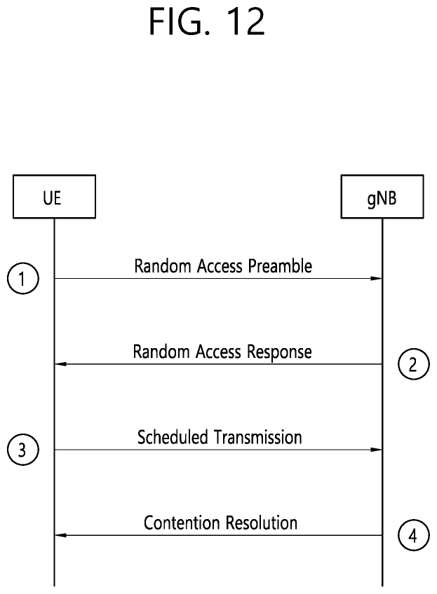

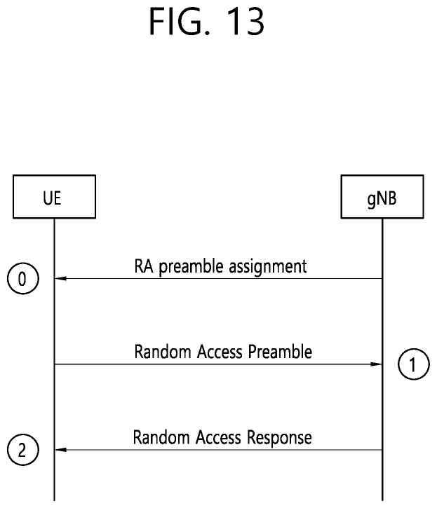

FIG. 12 shows an example of contention-based random access (CBRA) to which implementations of the present disclosure is applied. FIG. 13 shows an example of contention-free random access (CFRA) to which implementations of the present disclosure is applied.

For random access in a cell configured with supplementary UL (SUL), the network can explicitly signal which carrier to use (UL or SUL). Otherwise, the UE selects the SUL carrier if and only if the measured quality of the DL is lower than a broadcast threshold. Once started, all uplink transmissions of the random access procedure remain on the selected carrier.

When CA is configured, the first three steps of CBRA always occur on the PCell while contention resolution (step 4) can be cross-scheduled by the PCell. The three steps of a CFRA started on the PCell remain on the PCell. CFRA on SCell can only be initiated by the gNB to establish timing advance for a secondary TAG: the procedure is initiated by the gNB with a PDCCH order (step 0) that is sent on a scheduling cell of an activated SCell of the secondary TAG, preamble transmission (step 1) takes place on the indicated SCell, and random access response (step 2) takes place on PCell.

Random access preamble sequences, of two different lengths are supported. Long sequence length 839 is applied with subcarrier spacings of 1.25 and 5 kHz and short sequence length 139 is applied with subcarrier spacings of 15, 30, 60 and 120 kHz. Long sequences support unrestricted sets and restricted sets of Type A and Type B, while short sequences support unrestricted sets only.

Multiple PRACH preamble formats are defined with one or more PRACH OFDM symbols, and different cyclic prefix and guard time. The PRACH preamble configuration to use is provided to the UE in the system information.

The UE calculates the PRACH transmit power for the retransmission of the preamble based on the most recent estimate pathloss and power ramping counter.

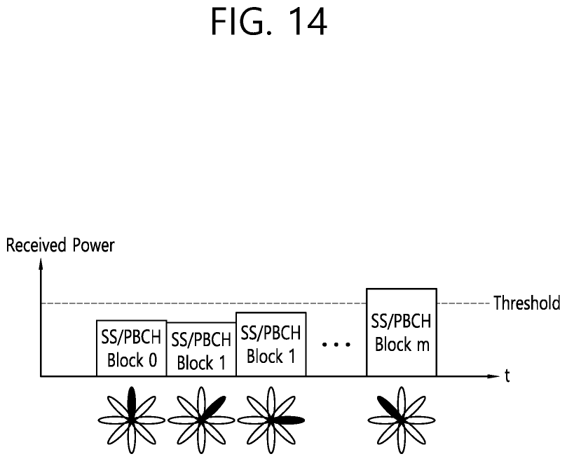

FIG. 14 shows a concept of threshold of the SSB for RACH resource association to which implementations of the present disclosure is applied.

The system information provides information for the UE to determine the association between the SSB and the RACH resources. The reference signal received power (RSRP) threshold for SSB selection for RACH resource association is configurable by network.

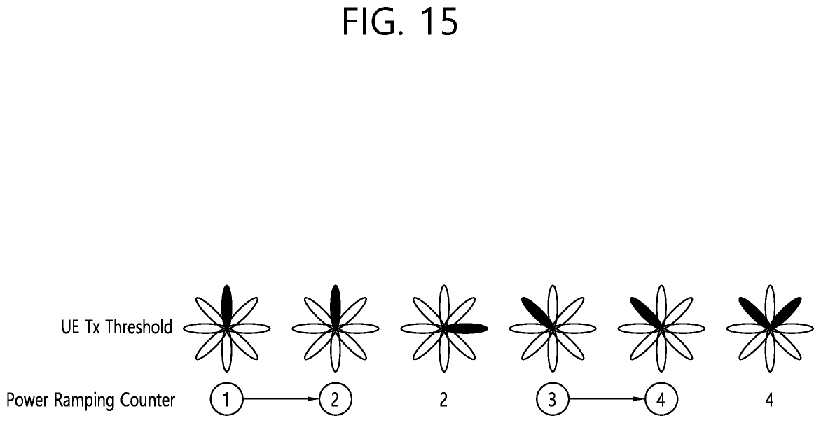

FIG. 15 shows an example of operation of power ramping counter to which implementations of the present disclosure is applied.

If the UE conducts beam switching, the counter of power ramping remains unchanged. For example, the UE may perform power ramping for retransmission of the random access preamble based on a power ramping counter. However, the power ramping counter remains unchanged if a UE conducts beam switching in the PRACH retransmissions. Referring to FIG. 15, the UE may increase the power ramping counter by 1, when the UE retransmit the random access preamble for the same beam. However, when the beam had been changed, the power ramping counter remains unchanged.

RRC_IDLE state and RRC_INACTIVE state is described. Section 4.1 of 3GPP TS 38.304 V15.2.0 (2018-12) can be referred.

The RRC_IDLE state and RRC_INACTIVE state tasks can be subdivided into three processes:
Public land mobile network (PLMN) selection;
Cell selection and reselection;
Location registration and RAN-based notification area (RNA) update.

PLMN selection, cell reselection procedures, and location registration are common for both RRC_IDLE state and RRC_INACTIVE state. RNA update is only applicable for RRC_INACTIVE state. When UE selects a new PLMN, UE transits from RRC_INACTIVE to RRC_IDLE.

When a UE is switched on, a PLMN is selected by NAS. For the selected PLMN, associated RAT(s) may be set. The NAS shall provide a list of equivalent PLMNs, if available, that the AS shall use for cell selection and cell reselection.

With cell selection, the UE searches for a suitable cell of the selected PLMN, chooses that cell to provide available services, and monitors its control channel. This procedure is defined as “camping on the cell”.

The UE shall, if necessary, then register its presence, by means of a NAS registration procedure, in the tracking area of the chosen cell. As an outcome of a successful location registration, the selected PLMN then becomes the registered PLMN.

If the UE finds a more suitable cell, according to the cell reselection criteria, it reselects onto that cell and camps on it. If the new cell does not belong to at least one tracking area to which the UE is registered, location registration is performed. In RRC_INACTIVE state, if the new cell does not belong to the configured RNA, an RNA update procedure is performed.

If necessary, the UE shall search for higher priority PLMNs at regular time intervals and search for a suitable cell if another PLMN has been selected by NAS.

If the UE loses coverage of the registered PLMN, either a new PLMN is selected automatically (automatic mode), or an indication of available PLMNs is given to the user so that a manual selection can be performed (manual mode).

Registration is not performed by UEs only capable of services that need no registration.

The purpose of camping on a cell in RRC_IDLE state and RRC_INACTIVE state is fourfold:

a) It enables the UE to receive system information from the PLMN.
b) When registered and if the UE wishes to establish an RRC connection or resume a suspended RRC connection, it can do this by initially accessing the network on the control channel of the cell on which it is camped.
c) If the network needs to send a message or deliver data to the registered UE, it knows (in most cases) the set of tracking areas (in RRC_IDLE state) or RNA (in RRC_INACTIVE state) in which the UE is camped. It can then send a paging message for the UE on the control channels of all the cells in the corresponding set of areas. The UE will then receive the paging message and can respond.
d) It enables the UE to receive ETWS and CMAS notifications.

When the UE is in RRC_IDLE state, upper layers may deactivate AS layer when mobile initiated communication only (MICO) mode is activated. When MICO mode is activated, the AS configuration (e.g., priorities provided by dedicated signaling) is kept and all running timers continue to run but the UE need not perform any idle mode tasks. If a timer expires while MICO mode is activated, it is up to the UE implementation whether it performs the corresponding action immediately or the latest when MICO mode is deactivated. When MICO mode is deactivated, the UE shall perform all idle mode tasks.

Cell selection and cell reselection is described. Section 5.2 of 3GPP TS 38.304 V15.2.0 (2018-12) can be referred.

UE shall perform measurements for cell selection and reselection purposes.

When evaluating Srxlev and Squal of non-serving cells for reselection evaluation purposes, the UE shall use parameters provided by the serving cell and for the final check on cell selection criterion, the UE shall use parameters provided by the target cell for cell reselection.

The NAS can control the RAT(s) in which the cell selection should be performed, for instance by indicating RAT(s) associated with the selected PLMN, and by maintaining a list of forbidden registration area(s) and a list of equivalent PLMNs. The UE shall select a suitable cell based on RRC_IDLE or RRC_INACTIVE state measurements and cell selection criteria.

In order to expedite the cell selection process, stored information for several RATs, if available, may be used by the UE.

When camped on a cell, the UE shall regularly search for a better cell according to the cell reselection criteria. If a better cell is found, that cell is selected. The change of cell may imply a change of RAT.

The NAS is informed if the cell selection and reselection result in changes in the received system information relevant for NAS.

For normal service, the UE shall camp on a suitable cell, monitor control channel(s) of that cell so that the UE can:

> receive system information from the PLMN; and

>> receive registration area information from the PLMN, e.g., tracking area information; and

>> receive other AS and NAS Information; and

> if registered:

>> receive paging and notification messages from the PLMN; and

>> initiate transfer to connected mode.

For cell selection in multi-beam operations, measurement quantity of a cell is up to UE implementation.

For cell reselection in multi-beam operations, the measurement quantity of this cell is derived amongst the beams corresponding to the same cell based on SS/PBCH block as follows:

> if nrofSS-BlocksToAverage is not configured in SIB2; or

> if absThreshSS-BlocksConsolidation is not configured in SIB2; or

> if the highest beam measurement quantity value is below or equal to absThreshSS-BlocksConsolidation:

>> derive a cell measurement quantity as the highest beam measurement quantity value.

> else:

>> derive a cell measurement quantity as the linear average of the power values of up to nrofSS-BlocksToAverage of highest beam measurement quantity values above absThreshSS-BlocksConsolidation.

For tracking area registration, in the UE, the AS shall report tracking area information to the NAS.

If the UE reads more than one PLMN identity in the current cell, the UE shall report the found PLMN identities that make the cell suitable in the tracking area information to NAS.

Reception of tracking area code (TAC) is described in detail.

Table 7 shows an example (e.g., a part of) of the SIB1 message. SIB1 contains information relevant when evaluating if a UE is allowed to access a cell and defines the scheduling of other system information. It also contains radio resource configuration information that is common for all UEs and barring information applied to the unified access control.

TABLE 7
-- ASN1START
-- TAG-SIB1-START
SIB1 ::= SEQUENCE {

| | |
|---|---|
| cell SelectionInfo | SEQUENCE { |

| q-RxLevMin | Q-RxLevMin, | |
|---|---|---|
| q-RxLevMinOffset | INTEGER (1..8) | OPTIONAL, -- Need S |

| | | |
|---|---|---|
| q-RxLevMinSUL | Q-RxLevMin | OPTIONAL, -- Need R |

| | | |
|---|---|---|
| q-QualMin | Q-QualMin | OPTIONAL, -- Need S |

| | | |
|---|---|---|
| q-QualMinOffset | INTEGER (1..8) | OPTIONAL -- Need S |

| | |
|---|---|
| } | OPTIONAL, -- Cond Standalone |

| cellAccessRelatedInfo | CellAccessRelatedInfo, | |
|---|---|---|
| connEstFailureControl | ConnEstFailureControl | OPTIONAL, -- Need R |

| | | |
|---|---|---|
| si-SchedulingInfo | SI-SchedulingInfo | OPTIONAL, -- Need R |

| | | |
|---|---|---|
| servingCellConfigCommon | ServingCellConfigCommonSIB | OPTIONAL, -- Need R |

| | | |
|---|---|---|
| ims-EmergencySupport | ENUMERATED {true} | OPTIONAL, -- Need R |

| | | |
|---|---|---|
| eCallOverIMS-Support | ENUMERATED {true} | OPTIONAL, -- Cond Absent |

| | | |
|---|---|---|
| ue-TimersAndConstants | UE-TimersAndConstants | OPTIONAL, -- Need R |

...

}
...
-- TAG-SIB1-STOP
-- ASN1STOP

Referring to Table 7, the SIB1 message includes CellAccessRelatedInfo information element (IE) in cellSelectionInfo IE, which includes parameters for cell selection related to the serving cell.

Table 8 shows an example (e.g., a part of) of the CellAccessRelatedInfo IE. The CellAccessRelatedInfo IE indicates cell access related information for this cell.

TABLE 8
-- ASN1START
-- TAG-CELL-ACCESS-RELATED-INFO-START

| CellAccessRelatedInfo ::= | | SEQUENCE { |
|---|---|---|
| | plmn-IdentityList | PLMN-IdentityInfoList, |

| | | |
|---|---|---|
| cellReservedForOtherUse | ENUMERATED {true} | OPTIONAL, -- Need R |

...

}
-- TAG- CELL-ACCESS-RELATED-INFO-STOP
-- ASN1STOP

Referring to Table 8, the CellAccessRelatedInfo IE includes plmn-IdentityList IE. The PLMN-IdentityList IE is used to configure a set of PLAM-IdentityInfo elements. Each of those elements contains a list of one or more PLMN Identities and additional information associated with those PLMNs. The total number of PLMNs in the PLMNIdentitynfoList does not exceed 12. The PLMN index is defined as b1+b2+ . . . b(n−1)+i If this PLMN is included at the n-th entry of PLMN-IdentityInfoList and the i-th entry of its corresponding PLMN-IdentityInfo, where b(j) is the number of PLMN-Identity entries in each PLMN-IdentityInfo respectively.

Table 9 shows an example (e.g., a part of) of the PLMN-IdentityInfoList IE. The PLMN-IdentityInfoList IE includes a list of PLMN identity information.

TABLE 9
-- ASN1START
-- TAG-PLMN-IDENTITY-LIST-START

| | |
|---|---|
| PLMN-IdentityInfoList ::= | SEQUENCE (SIZE (1..maxPLMN)) OF PLMN- |

IdentityInfo

| | |
|---|---|
| PLMN-IdentityInfo ::= | SEQUENCE { |

| | |
|---|---|
| plmn-IdentityList | SEQUENCE (SIZE (1..maxPLMN)) OF PLMN-Identity, |

| | | |
|---|---|---|
| trackingAreaCode | TrackingAreaCode | OPTIONAL, -- Need R |

| | | |
|---|---|---|
| ranac | RAN-AreaCode | OPTIONAL, -- Need R |

Referring to Table 9, the PLMN-IdentityInfoList IE may include TrackingAreaCode IE. The TrackingAreaCode IE is used to identify a tracking area within the scope of a PLMN. The TrackingAreaCode IE has a size of 24 bits.

Upon receiving the SIB1, the UE shall:

1> store the acquired SIB1;
1> if the cellAccessRelatedInfo contains an entry with the PLMN-Identity of the selected PLMN:
2> in the remainder of the procedures use plmn-IdentityList, trackingAreaCode, and cellIdentity for the cell as received in the corresponding PLMN-IdentityInfo containing the selected PLMN;
1> if in RRC_CONNECTED while T311 is not running:
2> disregard the frequencyBandList, if received, while in RRC_CONNECTED;
2> forward the cellIdentity to upper layers;
2> forward the trackingAreaCode to upper layers;
2> apply the configuration included in the servingCellConfigCommonSIB;
1> else:
2> if the UE supports one or more of the frequency bands indicated in the frequencyBandList for downlink and one or more of the frequency bands indicated in the frequencyBandList for uplink or one or more of the frequency bands indicated in the frequencyBandList for supplementary uplink, if configured, and they are not downlink only bands, and
2> if the UE supports at least one additionalSpectrumEmission in the NR-NS-PmaxList within the frequencyBandList of FrequencyInfoUL-SIB for FDD or of FrequencyInfoDL-SIB for TDD for the frequency band selected by the UE (for the downlink and uplink or supplementary uplink, if configured), and
2> if the UE supports the bandwidth of the initial uplink BWP and of the initial downlink BWPs indicated in the locationAndBandwidth fields:
3> forward the cellIdentity to upper layers;
3> forward the trackingAreaCode to upper layers;
3> if in RRC_INACTIVE and the forwarded trackingAreaCode does not trigger message transmission by upper layers:
4> if the serving cell does not belong to the configured ran-NotificationAreaInfo:
5> initiate an RNA update;
3> forward the ims-EmergencySupport to upper layers, if present;
3> forward the eCallOverIMS-Support to upper layers, if present;
3> apply the configuration included in the servingCellConfigCommon;
3> apply the specified PCCH configuration;
3> if the UE has a stored valid version of a SIB that the UE requires to operate within the cell:
4> use the stored version of the required SIB;
3> if the UE has not stored a valid version of a SIB of one or several required SIB(s):
4> for the SI message(s) that, according to the si-SchedulingInfo, contain at least one required SIB and for which si-BroadcastStatus is set to broadcasting:
5> acquire the SI message(s);
4> for the SI message(s) that, according to the si-SchedulingInfo, contain at least one required SIB and for which si-BroadcastStatus is set to notBroadcasting:
5> trigger a request to acquire the SI message(s);
3> apply the first listed additionalSpectrumEmission which it supports among the values included in NR-NS-PmaxList within frequencyBandList;
3> if the additionalPmax is present in the same entry of the selected additionalSpectrumEmission within NR-NS-PmaxList:
4> apply the additionalPmax;
3> else:
4> apply the p-Max;
2> else:
3> consider the cell as barred; and
3> perform barring as if intraFreqReselection is set to notAllowed;

Non-terrestrial networks (NTN) in 5G NR is described. Section 3 and Section 4.3 of 3GPP TR 38.811 V15.0.0 (2018-06) can be referred.

NTN means networks, or segments of networks, using an airborne or space-borne vehicle to embark a transmission equipment relay node or base station. In NTN, the following definitions may be used.
Aerial: an airborne vehicle embarking a bent pipe payload or a regenerative payload telecommunication transmitter, typically at an altitude between 8 to 50 km.
Airborne vehicles: unmanned aircraft systems (UAS) encompassing tethered UAS (TUA), lighter than air UAS (LTA), heavier than air UAS (HTA), all operating in altitudes typically between 8 and 50 km including high altitude platforms (HAPs)
Availability: % of time during which the RAN is available for the targeted communication. The RAN may contain several access network components among which an NTN to achieve multi-connectivity or link aggregation.
Beam throughput: data rate provided in a beam
Bentpipe payload: payload that changes the frequency carrier of the uplink RF signal, filters and amplifies it before transmitting it on the downlink
Connectivity: capability to establish and maintain data/voice/video transfer between networks and parts thereof
Geostationary Earth orbit (GEO): Circular orbit at 35,786 kilometres above the Earth's equator and following the direction of the Earth's rotation. An object in such an orbit has an orbital period equal to the Earth's rotational period and thus appears motionless, at a fixed position in the sky, to ground observers.
Low Earth orbit (LEO): Orbit around the around Earth with an altitude between 500 kilometres (orbital period of about 88 minutes), and 2,000 kilometres (orbital period of about 127 minutes).
Medium Earth orbit (MEO): region of space around the Earth above LGO and below GEO.
Mobile Services: a radio communication service between mobile and land stations, or between mobile stations
Mobile Satellite Services: A radio communication service between mobile earth stations and one or more space stations, or between space stations used by this service; or between mobile earth stations by means of one or more space stations
Non geostationary Satellites: Satellites (LEO and MEO) orbiting around the Earth with a period that varies approximately between 1.5 hour and 10 hours. It is necessary to have a constellation of several Non geostationary satellites associated with handover mechanisms to ensure a service continuity.
On Board processing: digital processing carried out on uplink RF signals aboard a satellite or an aerial.
One way latency: time required to propagate through the RAN from a terminal to the gateway or from the gateway to the terminal. This is especially used for voice and video conference applications.
Regenerative payload: payload that transforms and amplifies an uplink RF signal before transmitting it on the downlink. The transformation of the signal refers to digital processing that may include demodulation, decoding, re-encoding, re-modulation and/or filtering.
Relay node: Relay of Uu radio interface. The relay function can take place at Layer 1, 2 or 3.
Reliability: probability that the RAN performs in a satisfactory manner for a given period of time when used under specific operating conditions. The RAN may contain several access network components including an NTN to achieve multi-connectivity or link aggregation.
Round trip delay (RTD): time required for a network communication to travel from a terminal to the gateway or from the gateway to the terminal and back. This is especially used for web based applications.
Satellite: a space-borne vehicle embarking a bent pipe payload or a regenerative payload telecommunication transmitter, placed into LEO typically at an altitude between 500 km to 2000 km, MEO typically at an altitude between 8000 to 20000 km, or GEO at 35 786 km altitude.
Space-borne vehicles: Satellites including LEO satellites, MEO satellites, GEO satellites as well as highly elliptical orbiting (HEO) satellites
User Connectivity: capability to establish and maintain data/voice/video transfer between networks and Terminals
User Throughput: data rate provided to a terminal

NTN access typically features the following system elements:
NTN terminal: It may refer to directly the 3GPP UE or a terminal specific to the satellite system in case the satellite doesn't serve directly 3GPP UEs.
A service link which refer to the radio link between the user equipment and the space/airborne platform. In addition, the UE may also support a radio link with terrestrial based RAN.
A space or an airborne platform embarking a payload which may implement either a bent-pipe or a regenerative payload configuration.
Inter satellite/aerial links (ISL) in case of regenerative payload and a constellation of satellites. ISL may operate in RF frequency or optical bands.
Gateways that connect the satellite or aerial access network to the core network
Feeder links which refer to the radio links between the gateways and the space/airborne platform

Two types of satellite and aerial access network may be distinguished as follows.
Broadband access network serving very small aperture terminals that can be fixed or mounted on a moving platform (e.g., bus, train, vessel, aircraft, etc.). In this context, broadband refers to at least 50 Mbps data rate and even up to several hundred Mbps (satellite) or even up to several Gbps (aerial) on the downlink. The service links operate in frequency bands allocated to satellite and aerial services (Fixed, Mobile) above 6 GHz.
Narrow or wide band access network serving terminals equipped with omni or semi directional antenna (e.g. handheld terminal). In this context, narrowband refers to less than 1 or 2 Mbps data rate on the downlink. The service links operate typically in frequency bands allocated to mobile satellite or aerial services below 6 GHz.

Also, satellite and aerial systems with ISL or inter-aerial links (IAL) and those without ISL/IAL may be distinguished.

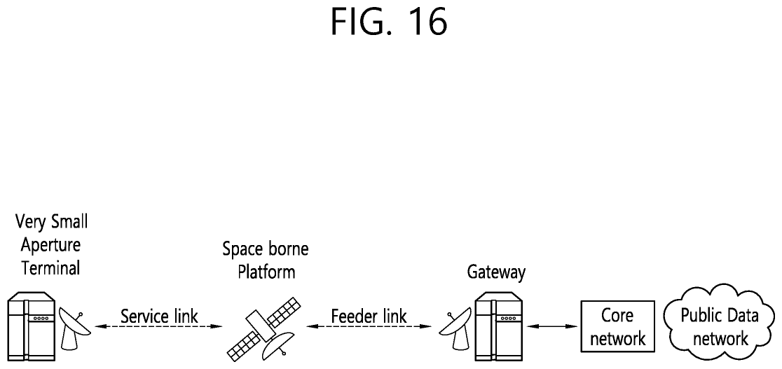

FIG. 16 shows an example of satellite access network (without ISL) with a service link operating in frequency bands above 6 GHz allocated to fixed and mobile satellite services (FSS and MSS) to which implementations of the present disclosure is applied.

Referring to FIG. 16, a very small aperture terminals that can be fixed or mounted on a moving platform is connected to a spaceborne platform via a service link. The spaceborne platform is connected to a gateway via a feeder link.

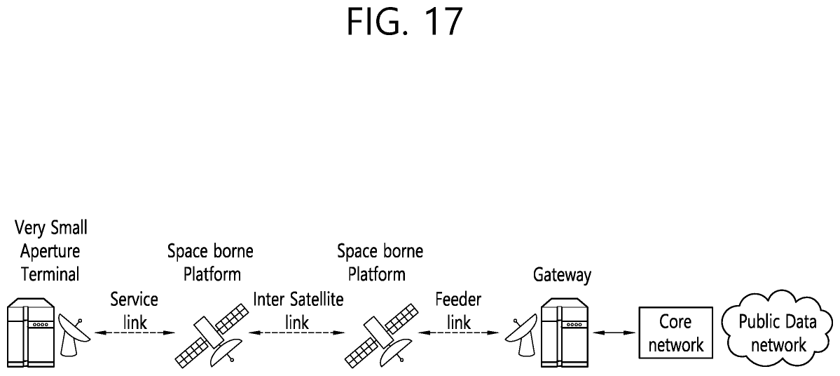

FIG. 17 shows an example of satellite access network (with ISL) with a service link operating in frequency bands above 6 GHz allocated to FSS and MSS to which implementations of the present disclosure is applied.

Referring to FIG. 17, a very small aperture terminals that can be fixed or mounted on a moving platform is connected to a first spaceborne platform via a service link. The first spaceborne platform is connected to a second spaceborne platform via ISL. The second spaceborne platform is connected to a gateway via a feeder link.

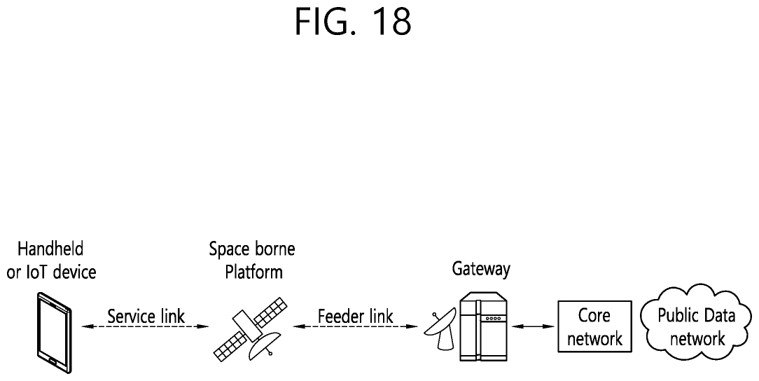

FIG. 18 shows an example of satellite access network with a service link operating in frequency bands below 6 GHz allocated to MSS to which implementations of the present disclosure is applied.

Referring to FIG. 18, a handheld device and/or IoT device is connected to a spaceborne platform via a service link. The spaceborne platform is connected to a gateway via a feeder link.

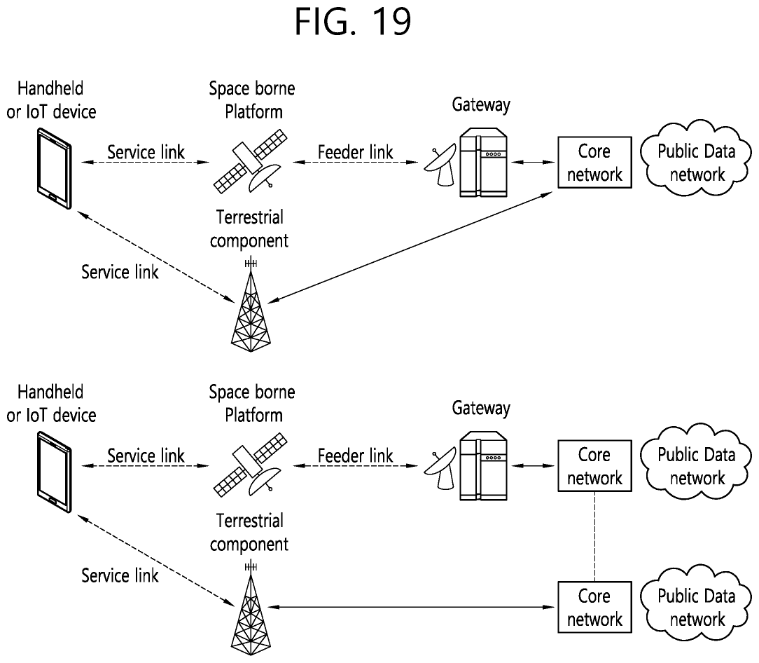

FIG. 19 shows an example of satellite access network which service link operates below 6 GHz frequency bands allocated to MSS and complemented with the terrestrial access network served by the same or independent core networks to which implementations of the present disclosure is applied.

Referring to FIG. 19, a handheld device and/or IoT device is connected to a spaceborne platform via a service link. The spaceborne platform is connected to a gateway via a feeder link. Furthermore, a handheld device and/or IoT device is connected to a terrestrial component via a service link. The terrestrial component is connected to core network.

In the current location management mechanism in LTE and/or NR, a number of cells are grouped into a tracking area. A UE may receive tracking area identity (TAI) list by network during registration procedure. The TAI may be combination of PLMN and TAC. Each cell may have its TAC. While in RRC_IDLE and/or RRC_INACTIVE state, when the UE performs cell selection and/or cell reselection to a new cell, the UE may check whether TAC received via SIB1 belongs to the TAI list. If the TAC received via SIM by the new serving cell does not belong to the TAI list, the UE may trigger tracking area update.

However, in NTN, different approach on the tracking area mechanism may be needed, specifically for non-GEO satellite which has moving beams on Earth. On the other hand, GEO satellite is located at a fixed position in the sky, so different approach on the tracking area mechanism may not be needed.

If the existing tracking area management in which a tracking area includes a number of cells fixed and each cell broadcasts its TAC is used, the non-GEO satellite with moving beam on Earth may also broadcast their TAC. In this case, as the non-GEO satellite only appears few minutes to a UE on the ground and the UEs may check their TAC whenever the non-GEO satellite appears, the UE which is even stationary may trigger frequent tracking area update.

Therefore, in order not to have tracking area update performed frequently by the UE triggered by the satellite motion, the tracking area may be designed to be fixed on ground. For non-GEO satellite, this implies that while the cells sweep on the ground, the TAC broadcasted is changed when the cell arrives to the area of next planned earth fixed tracking area location.

In detail, tracking area may be fixed in geographical area. The network may configure tracking areas with each geographical area and information on mapping between the geographical areas and tracking area may be provided to the UE. The UE may be required to know its current location. Based on the current location and the mapping information between the geographical areas and tracking area, the UE may know which tracking area itself is currently located in. If the UE moves to another geographical position with different tracking area, the UE may trigger tracking area update.

For example, the land may be divided into geographical areas, and each area may be mapped to TAC. For example, geographical area of Germany may be set to TAC=1, and that of France may be set to TAC=2. Therefore, if a UE's current location is in geographical area of Germany, then the UE may calculate its TAI list with TAC=1. If it moves to France, the TAC may be changed to 2.

To support geographically-fixed tracking area, the network may need to broadcast the TAC list dynamically. For the case of non-GEO satellite, which are moving around the Earth every few hours, TAC may be updated dynamically according to the covered areas by its beam. The TAC, or a list of TACs, broadcasted by the gNB needs to be updated as the gNB enters to the area of next planned tracking area. When the UE detects entering a tracking area that is not in the list of tracking areas that the UE previously registered in the network, a mobility registration update procedure will be triggered.

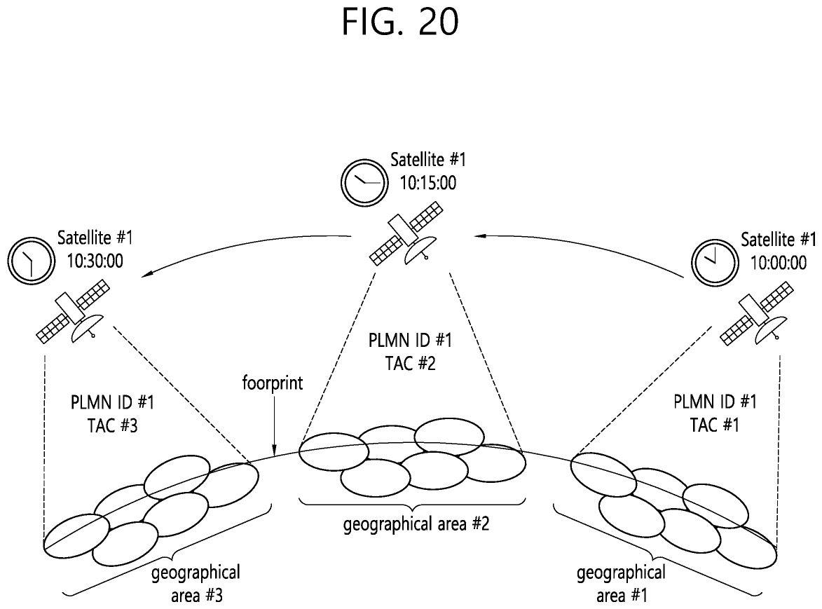

FIG. 20 shows an example of updating TAC and PLMN ID in real-time to which implementations of the present disclosure is applied.

Referring to FIG. 20, network updates the broadcast TAC in real time according to the ephemeris and confirm the broadcast TAC is associated with the geographical area covered by the satellite beam. For example, at 10:00:00, the satellite #1 covers geographical area #1, which is mapped to TAC #1. The satellite #1 broadcasts TAC #1. At 10:15:00, the satellite #1 covers geographical area #2, which is mapped to TAC #2. The satellite #1 broadcasts TAC #2. At 10:30:00, the satellite #1 covers geographical area #3, which is mapped to TAC #3. The satellite #1 broadcasts TAC #3.

The UE may listen to TAI=PLMN ID+TAC and determines to trigger registration area update procedure based on the broadcast TAC and PLMN ID when it moves out of the registration area.

However, the non-GEO satellite may not want to provide TACs for all of the geographical areas that currently being served by its beam. For example, operator in some country may not provide NTN service. That is, in some area, the gNB may not be able to provide NTN service and thus not broadcast TAC(s). Therefore, if the non-GEO satellite does not broadcast TAC of a geographical area being covered and a UE staying in the geographical area receives the broadcast TAC list from the satellite, the UE which is stationary may need to perform unnecessary tracking area update.

According to the present disclosure, while a wireless device (e.g., UE) is using NTN, if a NTN cell does not provide TAC corresponding to the current geographical area that wireless device is currently located, the UE may de-prioritize the NTN cell in order to prevent camping on the NTN cell.

The following drawings are created to explain specific embodiments of the present disclosure. The names of the specific devices or the names of the specific signals/messages/fields shown in the drawings are provided by way of example, and thus the technical features of the present disclosure are not limited to the specific names used in the following drawings.

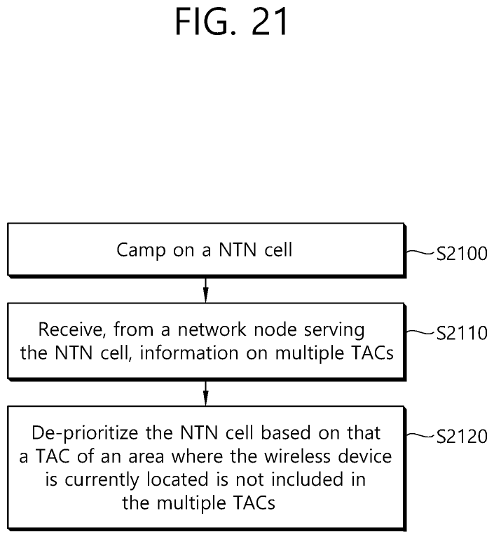

FIG. 21 shows an example of a method for a wireless device to which implementations of the present disclosure is applied.

In some implementations, the method in perspective of the wireless device described below may be performed by first wireless device 100 shown in FIG. 2, the wireless device 100 shown in FIG. 3, the first wireless device 100 shown in FIG. 4 and/or the UE 100 shown in FIG. 5.

In some implementations, the method in perspective of the wireless device described below may be performed by control of the processor 102 included in the first wireless device 100 shown in FIG. 2, by control of the communication unit 110 and/or the control unit 120 included in the wireless device 100 shown in FIG. 3, by control of the processor 102 included in the first wireless device 100 shown in FIG. 4 and/or by control of the processor 102 included in the UE 100 shown in FIG. 5.

In some implementations, the method in perspective of the network described below may be performed by second wireless device 200 shown in FIG. 2, the wireless device 200 shown in FIG. 3 and/or the second wireless device 200 shown in FIG. 4.

In some implementations, the wireless device (e.g., UE) may be in communication with at least one of a mobile device, a network, and/or autonomous vehicles other than the wireless device.

In some implementations, a network node serving a NTN cell may include a non-geostationary satellite orbiting around the Earth with a period which is less than earth's rotational period, i.e., 24 hours.

In step S2100, the wireless device camps on the NTN cell.

In step S2110, the wireless device receives, from the network node serving the NTN cell, information on multiple TACs.

In some implementations, the wireless device may be provided with mapping information between geographical areas and tracking areas. Each of the geographical areas may be mapped to each of the multiple TACs. Based on the mapping information, the wireless device may evaluate its TAI list. A single tracking area and/or multiple tracking areas may be configured in each geographical area.

In some implementations, the mapping information may be provided by the network, via broadcast signaling and/or dedicated signaling. For example, the mapping information may be provided to the wireless device from birth, i.e., the mapping information may be pre-configured to the wireless device.

In some implementations, for evaluation of the TAI list, the mapping information, the current location information of the wireless device and/or registered PLMN may be used.

In some implementations, when the wireless device moves to a new geographical area, the wireless device may trigger tracking area update with the tracking area corresponding to the new geographical area.

In some implementations, the wireless device may acquire system information (e.g., SIB1) of the serving cell, or new NTN cell upon performing cell selection and/or cell reselection. From the acquired system information, the wireless device may know where the wireless device is currently located, e.g., current location of the wireless device. Based on the current location of the wireless device, the wireless device may know TAC corresponding to the current location of the wireless device.

In step S2120, the wireless device de-prioritizes the NTN cell based on that a TAC of an area where the wireless device is currently located is not included in the multiple TACs.

In some implementations, the wireless device may check whether the TAC corresponding to the current location of the wireless device is included in the multiple TACs, which is received from the network node in step S2110. The wireless device may check whether the TAC corresponding to the current location of the wireless device belongs to the current TAI list of the wireless device. If the TAC corresponding to the current location of the wireless device is not included in the multiple TACs and/or the TAC corresponding to the current location of the wireless device does not belong to the current TAI list of the wireless device, the wireless device may de-prioritize the NTN cell. The NTN cell may be de-prioritized for a certain time period.

For the de-prioritization of the NTN cell, at least one of the followings operations may be performed.

(1) The wireless device may consider the NTN cell as barred. That is, the de-prioritization of the NTN cell may comprise barring the NTN cell.

Being considered as barred, the wireless device may exclude the NTN cell as a candidate for cell selection/reselection for up to a certain time period. The certain time period may be provided from network via broadcast signaling and/or dedicated signaling.

(2) The wireless device may temporarily apply a cell-specific offset to the NTN cell.

That is, the de-prioritization of the NTN cell may comprise applying a cell-specific offset to the NTN cell for cell selection and/or cell reselection.

After immediately applying the cell-specific offset to the NTN cell, if the NTN cell still satisfies cell reselection criteria, the wireless device may perform cell reselection to the NTN cell.

(3) The wireless device may temporarily apply a frequency-specific offset to the NTN cell and cells on the same frequency. The wireless device may temporarily apply a frequency-specific offset to a current frequency on which the NTN cell operates. That is, the de-prioritization of the NTN cell may comprise applying a frequency-specific offset to a frequency on which the NTN cell operates for cell selection and/or cell reselection.

After immediately applying the frequency-specific offset to the current frequency on which the NTN cell operates, if one of cells on the current frequency satisfies cell reselection criteria, the wireless device may perform cell reselection to the NTN cell.

(4) The wireless device may consider the current frequency on which the NTN cell operates to be the lowest priority frequency (i.e., lower than any of the network configured values). That is, the de-prioritization of the NTN cell may comprise considering a current frequency on which the NTN cell operates to be a lowest priority.

The wireless may not perform cell reselection to the NTN cell immediately. After that, if the NTN cell satisfies cell reselection criteria to a cell on a frequency which has lower priority than the current frequency, the UE may perform cell reselection to the NTN cell.

In some implementations, upon performing cell (re-)selection, the wireless device may establish a connection with network. The wireless device may perform initial access towards the selected cell. The wireless device and the selected cell may perform RACH procedure. The wireless device may establish or resume a connection with the network and enter RRC_CONNECTED. The wireless device may perform AS security activation upon receiving security mode command from the network. The wireless device may configure radio bearers and radio configuration upon receiving RRC reconfiguration or resumes radio bearers and radio configuration upon receiving RRC resume.

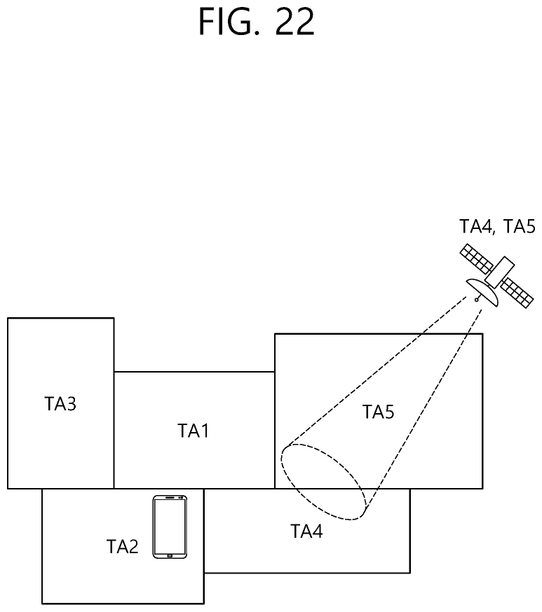

FIG. 22 shows an example of a NTN cell broadcasting geographical-fixed TACs at a first time point to which implementations of the present disclosure is applied.

Referring to FIG. 22, there are five geographical areas and each geographical area is mapped to each tracking area, i.e., TA1 to TA5. A UE is currently located at a geographical area with TA2, and the UE may know information related to tracking areas for each geographical area. At the first time point, a non-GEO satellite appears, and the current beam of the non-GEO satellite is serving two geographical areas, i.e., TA4 and TA5. So, the NTN cell broadcasts TAC4 and TAC5.

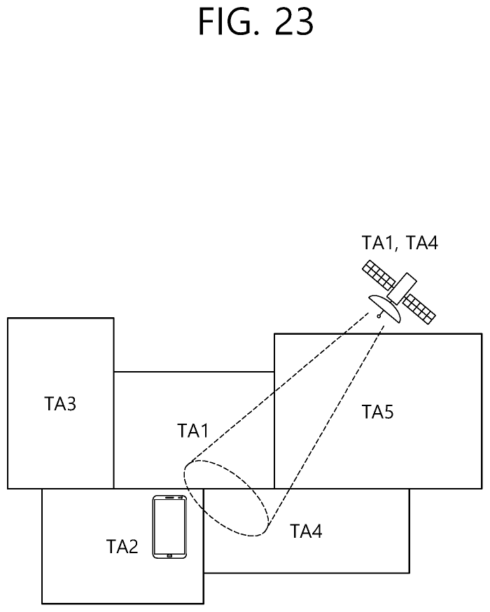

FIG. 23 shows an example of a NTN cell broadcasting geographical-fixed TACs at a second time point to which implementations of the present disclosure is applied.

Referring to FIG. 23, after a while, i.e., at the second time point, the NTN cell is serving three geographical areas, i.e., TA1, TA2 and TA4. The UE may receive the broadcast information of the NTN cell. However, the NTN cell does not want to provide service to geographical area with TA2. So the NTN cell only broadcasts TAC1 and TAC4.

According to the current tracking area mechanism, if the NTN cell satisfies the cell reselection criteria and the UE performs cell reselection to the NTN cell, the UE may perform tracking area update with TA2 after the cell reselection. But this is unwanted access for the network.

According to the present disclosure, upon acquiring the system information including TAC corresponding to the current location of the UE, but if the TAC does not belong to the TAI list of the UE, the UE may de-prioritize the NTN cell which may not want the UE to access. Therefore, the UE can reduce unnecessary signaling and/or mobility procedure.

The present disclosure can have various advantageous effects.

For example, for the UEs knowing its current location and corresponding TAI list, if an NTN cell broadcasts TAC(s) and the TAC(s) does not belong to the TAI list of the UE, the UE can de-prioritize the NTN cell to camp on.

For example, unnecessary access attempt and/or tracking area update can be prevented.

Advantageous effects which can be obtained through specific embodiments of the present disclosure are not limited to the advantageous effects listed above. For example, there may be a variety of technical effects that a person having ordinary skill in the related art can understand and/or derive from the present disclosure. Accordingly, the specific effects of the present disclosure are not limited to those explicitly described herein, but may include various effects that may be understood or derived from the technical features of the present disclosure.

Claims in the present disclosure can be combined in a various way. For instance, technical features in method claims of the present disclosure can be combined to be implemented or performed in an apparatus, and technical features in apparatus claims can be combined to be implemented or performed in a method. Further, technical features in method claim(s) and apparatus claim(s) can be combined to be implemented or performed in an apparatus. Further, technical features in method claim(s) and apparatus claim(s) can be combined to be implemented or performed in a method. Other implementations are within the scope of the following claims.

1. A method for a wireless device in a wireless communication system, the method comprising:
camping on a non-terrestrial networks (NTN) cell;
receiving, from a network node serving the NTN cell, information on multiple tracking area codes (TACs); and
de-prioritizing the NTN cell based on that a TAC of an area where the wireless device is currently located is not included in the multiple TACs.

2. The method of claim 1, wherein the de-prioritizing the NTN cell comprises barring the NTN cell.

3. The method of claim 2, wherein the NTN cell is excluded as a candidate for cell selection and/or cell reselection.

4. The method of claim 1, wherein the de-prioritizing the NTN cell comprises applying a cell-specific offset to the NTN cell for cell selection and/or cell reselection.

5. The method of claim 1, wherein the de-prioritizing the NTN cell comprises applying a frequency-specific offset to a frequency on which the NTN cell operates for cell selection and/or cell reselection.

6. The method of claim 1, wherein de-prioritizing the NTN cell comprises considering a current frequency on which the NTN cell operates to be a lowest priority.

7. The method of claim 1, wherein the NTN cell is de-prioritized for a certain time period.

8. The method of claim 1, wherein the network node serving the NTN cell includes a non-geostationary satellite orbiting around earth with a period which is less than earth's rotational period.

9. The method of claim 1, wherein each of the multiple TACs is mapped to each geographical area.

10. The method of claim 9, wherein a single tracking area is configured in each geographical area.

11. The method of claim 9, wherein multiple tracking areas are configured in each geographical area.

12. The method of claim 1, wherein the wireless device is in communication with at least one of a mobile device, a network, and/or autonomous vehicles other than the wireless device.

13. A wireless device in a wireless communication system, the wireless device comprising:
at least one transceiver;
at least processor; and
at least one computer memory operably connectable to the at least one processor and storing instructions that, based on being executed by the at least one processor, perform operations comprising:
camping on a non-terrestrial networks (NTN) cell;
receiving, from a network node serving the NTN cell, information on multiple tracking area codes (TACs); and
de-prioritizing the NTN cell based on that a TAC of an area where the wireless device is currently located is not included in the multiple TACs.

14. The wireless device of claim 13, wherein the de-prioritizing the NTN cell comprises barring the NTN cell.

15. The wireless device of claim 14, wherein the de-prioritizing the NTN cell comprises barring the NTN cell.

16. The wireless device of claim 13, wherein the de-prioritizing the NTN cell comprises applying a cell-specific offset to the NTN cell for cell selection and/or cell reselection.

17. The wireless device of claim 13, wherein the de-prioritizing the NTN cell comprises applying a frequency-specific offset to a frequency on which the NTN cell operates for cell selection and/or cell reselection.

18. The wireless device of claim 13, wherein de-prioritizing the NTN cell comprises considering a current frequency on which the NTN cell operates to be a lowest priority.

19. The wireless device of claim 13, wherein the NTN cell is de-prioritized for a certain time period.

20. (canceled)

21. A wireless device in a wireless communication system, the wireless device comprising:
at least one memory;
at least one processor coupled to the at least one memory, configured to:
camp on a non-terrestrial networks (NTN) cell;
obtain, from a network node serving the NTN cell, information on multiple tracking area codes (TACs); and
de-prioritize the NTN cell based on that a TAC of an area where the wireless device is currently located is not included in the multiple TACs.
